(19) United States
(12) Patent Application Publication
(10) Pub. No.: US 2011/0276361 A1
(43) Pub. Date: Nov. 10, 2011

(54) Method and Apparatus for Service Portfolio Manager (SPM)

(76) Inventor: Michael Hogan, St. Paul, MN (US)

(21) Appl. No.: 12/952,169

(22) Filed: Nov. 22, 2010

Related U.S. Application Data
(63) Continuation of application No. 12/798,112, filed on Mar. 29, 2010, now abandoned.
(60) Provisional application No. 61/211,395, filed on Mar. 27, 2009.

(51) Int. Cl. G06Q 10/00

(52) U.S. Cl. 705/7.27

(57) ABSTRACT

A computer program for organizing, reporting, analyzing and managing service portfolio supply chain information is disclosed. More specifically, the tool is a web-enabled, database application leveraged for defining, costing and managing the delivery of services throughout their full lifecycle while providing integration points for external tools as both inputs and outputs to the application for purposes of building a bridge between technology managers and business executives/finance mangers.

### FIELD OF THE INVENTION

The present invention is directed to a computer program for organizing, reporting, analyzing and managing service portfolio supply chain information. More specifically the tool is a web-enabled, database application leveraged for defining, costing and managing the delivery of services throughout their full lifecycle while providing integration points for external tools as both inputs and outputs to the application for purposes of building a bridge between technology managers and business executives/finance mangers.

### BACKGROUND

The benefits of virtual desktop computing are very compelling. Every day more of the drawbacks and risks are being mitigated. The technical and cost considerations have passed the tipping point. It has been found that now is the time to shift from supporting physical desktops to providing virtual desktops as a service to customers.

### BRIEF DESCRIPTION OF THE DRAWINGS

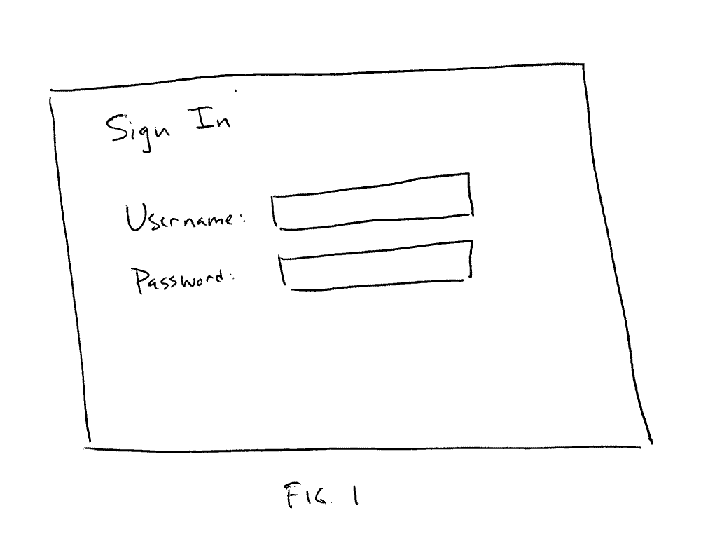

In accordance with one embodiment of the present invention, FIGS. 1-108 illustrate the environment and operation of the Service Portfolio Manager (SPM) database tool for integrating customer services management, enterprise architecture, technology service delivery and IT finance with the customers of IT using multiple application modules that provide discrete functionality, all with integration points to each other so that data consistency is preserved and duplication of effort is avoided.

### BRIEF DESCRIPTION

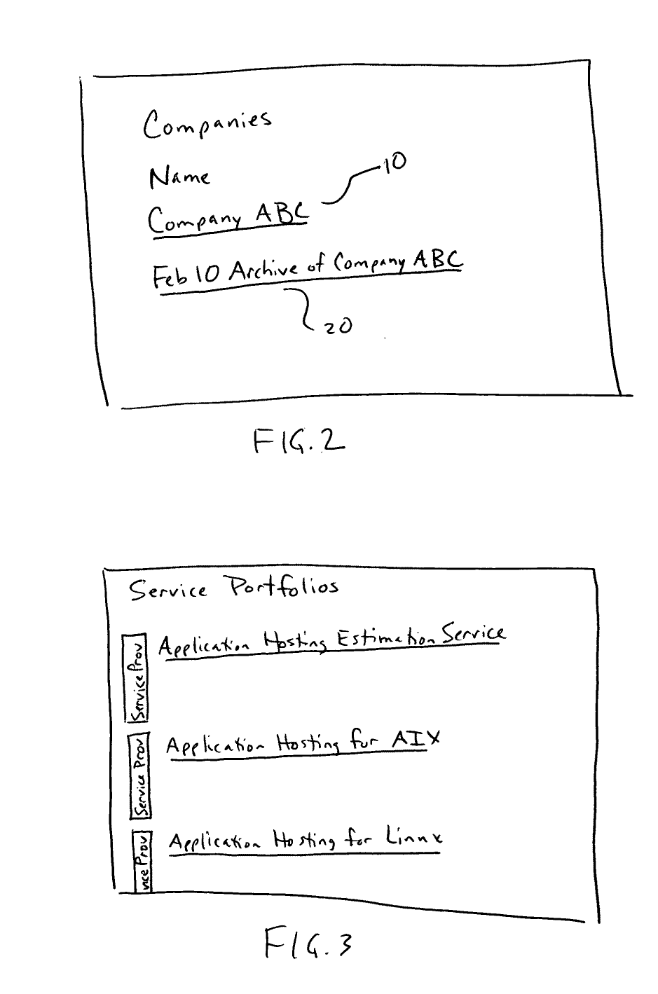

FIG. 1 illustrates one example of a standard log-in screen in accordance with one aspect of the present invention. A client begins by logging in to the particular site, and, since it is an Internet based tool, it is shown as a standard log-in screen. An SPM branded log-in screen is shown. FIG. 2 illustrates the information associated with the companies 10, 20. Any company shown in the company list can be modified or cloned. For example, one can clone the underlying information for an entire company. As illustrated and described later, one can also clone service portfolios, components, as well as multiple levels of cloning. All of the underlying information is configured to drive the “what if” decision support kind of analysis. The tool of the present invention is a way of being able to capture a base line of current state as well leveraging that current state to be able to do the cloning such that a user can do a lot of “what if” analysis and comparison against current state. FIG. 3 shows the home page of the company that becomes active upon clicking it from the company listing page. FIG. 4 illustrates the Company Settings for the selected company 20 from FIG. 2. FIG. 4b input screen 30 allows a user to enter data that defines company 20—for example, the name of the company 40, defaults gross number of hours 50 (e.g., 40 hours a week, 52 weeks a year, comes out to 2,080 default gross hours). It may be desirable to factor in a 45-hour work week. Default gross hours 50 is defined as a default and it can be overridden, as well as default time off for vacations and holidays associated with the company and/or employee. The example shown in FIG. 4b has set up default time off 60 as four weeks which nets out to 1920 hours. It is important for the present invention to capture the capacity and not just expense. The present invention is also about income with regards to consumption, and sometimes that income is a zero-sum gain for internal IT organizations or for service portfolios. For profit service portfolios, typically, it is a cost-plus type of model. The user continues by defining what the month the fiscal year is at location 65, and that becomes important because everything in this tool is time boxed. Draft states allows the user to specify whether the company is working with a proposed plan or is this already in production. In one example, if the company status is a draft mode, the indicator turns orange. And, if it is not in draft status, its production the status indicator 70 is unchecked, and it is in production.

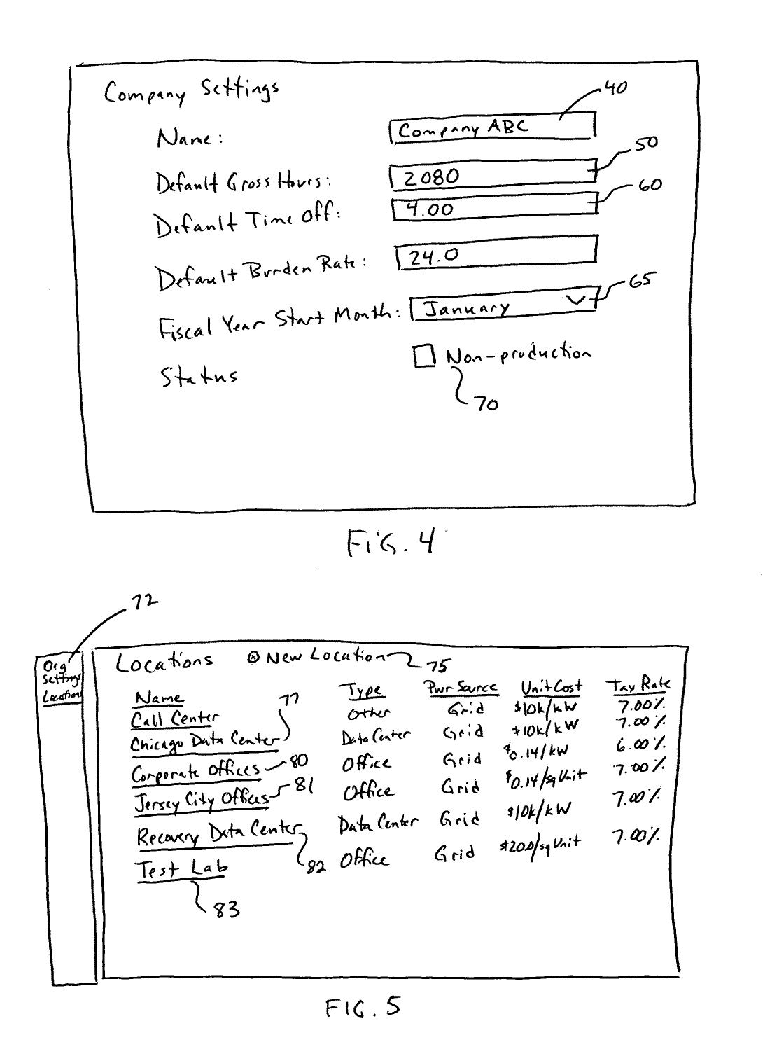

FIG. 5 identifies the location of resources 75 when a user selects the “Locations” hyperlink within the Organization Settings menu of the Settings 72. People resources and/or asset resources are associated with a company's locations for various reasons that will become apparent within this description. A list shows different data centers—e.g., Chicago Data Center 77. FIG. 5 also shows different offices—e.g. Corporate office 80, Jersey City Offices 81 and Recovery Data Centers 82 and Test Lab 83. Each location has the option of choosing one of two “location unit types”—either kW-hour or Sq. Unit. For example, data centers are more frequently being defined in terms of a cost per kilowatt-hour, whereas regional offices are typically defined in terms of a typical cost per square foot/meter. When power is the unit type for a location (e.g. data center) then the unit type will be kW-hour. The accommodation cost is calculated by the tool automatically factoring the total kW-hours per year applied to each power consuming asset (refer to the Portfolio Assets section for more detail on calculating power consumption) and multiplies it by this kW-hour unit cost. It is that value that the tool references for reporting.

FIG. 6 illustrates how to create a new location in accordance with another aspect of the present invention. Whatever the user selects as a name 86, identifies, where this location resides and what location type 84 best defines its attributes. Examples include whether the new location or building is a warehouse or a new campus building that's been built out, that may be used to analyze raw costs per square foot, or maybe it's a blended number for buildings in a campus, data center, office, etc.

Input Power Source 85 allows a user to define what the different power source options are so as to provide valuable information that may be used with a company's green initiative. It allows companies—in the same way the tool can track and allocate the costs and perform analytics on where expenses lie and where the capacities lie—to leverage that same methodology to capture power consumption (e.g., how much and what kind). If such an identification is done at the outset, then the ability to do that type of recording and analytics later becomes very simple. Location Cost Type 87 allows a user to specify the cost type for a particular location, for example, the unit cost may be a cost per kilowatt-hour, or a cost per square unit—this covers both square foot or square meter. Unit Cost input 88 defines the value of that unit cost. In the illustrated example, a $10 per kW-hour number is entered. The tool is programmed to use this unit cost for any asset that's installed within this data center. If a user defines what the footprint is in terms of space, the tool multiplies the footprint by the unit cost, and calculates the accommodations cost, which will be seen in one of the reports later in this description. A tax rate may be entered at location 89 where applicable. The tool is programmed to automatically factor the tax rate for any assets associated with the location. The person doing the input does not have to remember all of the different tax rates or track them by location—the user simply selects the location and if the tax rate is to be applied, and the tool will calculate the appropriate tax at the corresponding tax rate.

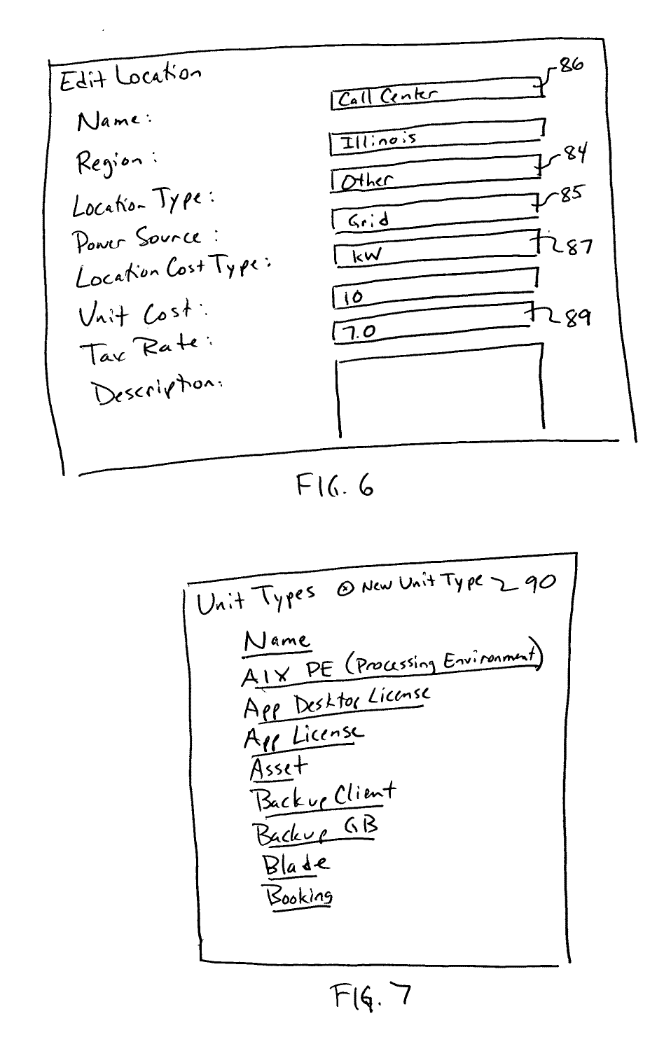

FIG. 7 shows the unit types 90 that are user-definable when a user selects the “Unit Types” hyperlink within the Organization Settings of Settings 72. The resulting list in unit type 90 shows the different possibilities when a user defines and analyzes the service portfolios described later. As shown herein, different service portfolios have a different unit type in a consumption-based cost model.

For example, storage is cost per gigabytes; servers are cost per server or cost per CPU; data base is costs per data base license; and applications might be cost per user, cost per project(s) or cost per hourly rates. In accordance with one aspect of the present invention, the users have the ability to define those without having to go into the code to do so. If the unit type of “Hours” is selected by a service portfolio then the tool automatically knows to look for that unit type in contracts—either internal or external contracts.

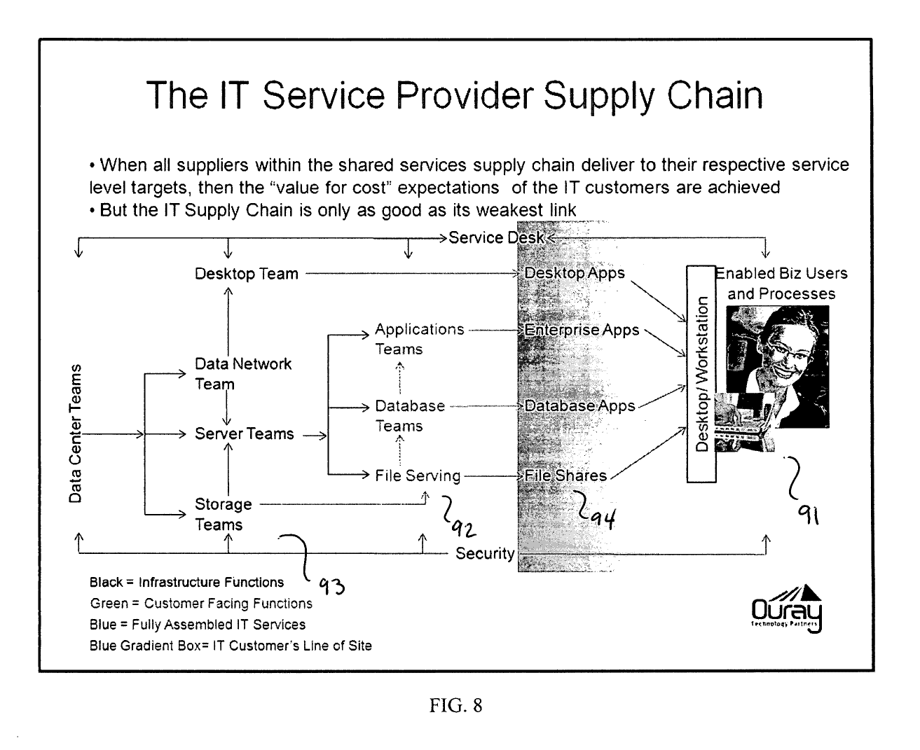

FIG. 8 illustrates the philosophy behind this tool, defined particularly as an IT services supply chain. One of ordinary skill in the art will recognize that the present invention may be used in many other instances, and therefore, describing in terms of an IT services supply chain shall not be limiting in any way.

And so the illustrated example starts from the customer side 91, everything that the customer engages IT for is coming through their computer experience, e.g., a desktop or laptop. The customer is typically accessing file shares on a file server or utilizing data base applications, enterprise applications, or desktop applications. To understand the purpose behind the current invention, one needs to understand what is behind touch points 91. The question becomes what does that supply chain look like? So, in order to deliver the applications or files shares effectively and efficiently, all pieces 92, 93 behind customer side 91 need to be in place and need to be understood. As the old adage goes, a system is only as good as its weakest link. Typically, this is where the vision ends for the customers, but in terms of how effectively or ineffectively or efficiently or inefficiently teams 92, 93 work, it will manifest itself in touch points 91 with the customers.

So, really, if we look at the different components 92, 93, though this is not exhaustive, it represents a typical complex services IT service supply chain. Everything behind an application at the customer level 91 is going to be the application itself, database, storage, servers, SAN, SAN fabric, back-up and restore, network, desktop, and data center taking into account overlay services around service and support for each and overall system security. It is desirable to monitor or analyze how each supplier is doing against their service-level targets that are aligned or should be aligned to provide the customer 91 a predictable user experience. Predictability is defined from a performance standpoint relative to both risk containment and cost. So, it is essentially a price-performance balance. Customers 91 do not always need the top end, even though IT typically feels the need to provide the best of everything. But the best of everything usually costs. The best solution equals is typically a full-range of service offerings that range from the top end (which is typically a small percentage at the time), to the medium range, to the lower range. And sometimes—because there's a need for the full range of services—the best solution is a balancing act of the full range of offerings.

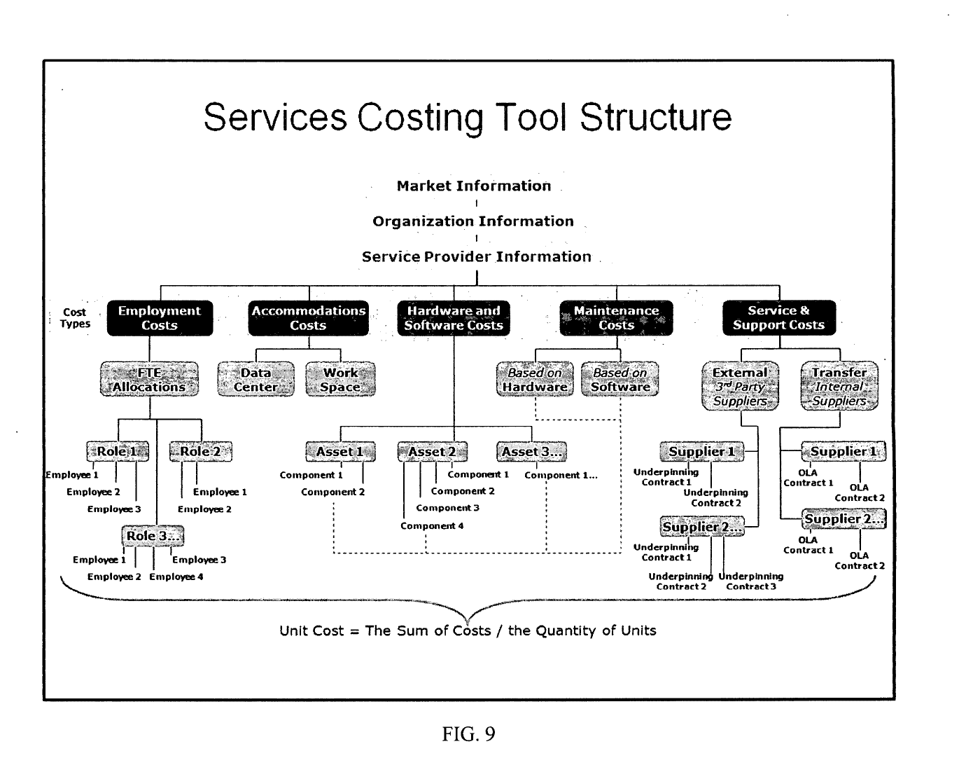

FIG. 9 illustrates a number of service portfolios in accordance with one aspect of the present invention. As used herein, a service portfolio is a functional team in the supply chain. So, examples are as follows: data centers are that cost per square foot or cost per kilowatt-hour; servers might be a cost per CPU or cost per processing unit or cost per server; storage is a cost per gigabyte; network is a cost per LAN port; applications are a cost per user. For example, using storage to illustrate the principals of FIG. 9 if we look at the storage component, the storage service portfolio in the supply chain, this is the framework that each service portfolio should be using. This framework complies with ITIL, and also complies with the standard GAAP principals. Any expense can be categorized generally in one of the five categories—i.e., Service and Support, Maintenance, Hardware and Software, Accommodations and Employment.

Accommodations expenses are defined as what was shown on the locations page—everything from data centers, buildings, campuses, etc. Hardware and software contracts and the associated maintenance is also shown. Service and support contracts are shown and defined as both external and internal contracts (i.e., internal suppliers).

Each expense category may be broken down further. Starting with the service and support costs, the two types of contracts can be broken down into a parent-child relationship. The question to ask is “who is the supplier?” If the supplier is external, ITIL calls such a contract an underpinning contract. If the supplier is internal, it's still considered a supplier in the supply chain, but that contract is an objective level agreement (OLA). And so service and support expense and capacity. If the OLA is not a bill back contract it should not be included as an expense. Otherwise that expense is being accounted for twice (once by the cost center that is paying for the asset and again for the internal customer of that cost center as it is manifest in the unit price). For hardware and software costs, the model is broken down again into a parent-child relationship. Each asset (e.g., Asset 1, Asset 2 and Asset 3) has no cost or capacity directly associated with it. Rather, the asset is defined by a unique identifier relative to the location within the organization in which it resides; where the asset's location is so the tool knows what tax rate to apply.

The component within the respective asset is the place in which the acquisition cost and raw capacity is defined within the example shown in FIG. 9b. For example, an organization might buy Asset 2 in Jan. 1, 2009 with Components 1 and 2 costing “x” amount of dollars for “x” amount of capacity. A year later, the organization runs out of capacity for Asset 2. The organization is not required to buy a whole new asset to replace Asset 2. Presumably, Asset 2 has scalability within it to add capacity, and the tool makes this possible by being able to add one or more components (Components 3 and 4), to an asset that represent this additional expense and capacity. This accurate allocation of capacity expense is important because to factor an expense-run rate properly, co-terminus must be factored in. Usually, when additional capacity is added, it is desirable to calculate appropriately from that new component's availability date (i.e., when the capacity becomes available) to the end date of the parent asset. And so if the asset is on a 3-year depreciation schedule and Components 3 and 4 are made available after year one, a calculation out over three years would be incorrect, it would make your run rate look artificially low. Calculations should be made as a 2-year run rate, so it's appropriately calculating the run rate based on the components being coterminous to the parent asset.

Each asset component must be classified as either “hardware” or “software”. If it is classified as “hardware” then the option becomes available to apply physical space and power values that may or may not contribute to that components cost. The tool will ask the user to identify the space in square units (this allows for metric or US measurement) and/or power consumption. Because power is identified in several different formats, the tool provides a “helper” that asks for the power values in the terms that are most typically provided by vendors (e.g. watts; VA; amperage; Btu; etc) and then converts to kW. The tool then walks the user through a few simple questions that capture the yearly usage that together provides the kW-hour value that is then multiplied by the kW-hour unit cost that is defined in the Company Location as was described earlier in this document.

Turning now to asset maintenance expenses as shown in the example of FIG. 9, maintenance is always associated with the components of assets. So, within the tool of the present invention every component has a flexibility of adding one or more maintenance contracts to it. When defining a maintenance contract the tool asks the user to identify the following: (i) the start date of the maintenance contract; and (ii) is the maintenance a pre-paid contract and if so, for how many years does the pre-paid contract extend (e.g. Standard 3 Yr Maintenance). In response to the answers, (i) the tool calculates the end date based on the identified contract start date plus the number of years selected for the pre-paid option; (ii) the tool amortizes the contract cost across the start and end of the contract; and (iii) the tool knows to tag this pre-paid expense as Capex due to its qualifying characteristic of being an expense that will be utilized in the future and improves the life of one or more assets; but it also knows to treat the amortization expenses as Opex. This becomes relevant when calculating TCO. The Capex is captured as the initial Yr 1 investment but the tool knows NOT to calculate the amortization Opex in the 5 Yr TCO (otherwise it would be double counting). This rule is exactly the same for purchased assets that are being depreciated.

In one embodiment, the tool will also ask the user to defined any additional maintenance contracts that will kick in after the pre-paid maintenance contract has expired (e.g. Extended Maintenance Contracts). The tool understands that if an extended contract is identified, that it must begin as of the expiration date of a previously defined contract. That way there is never a gap between years when a there is no maintenance. The tool understands to tag this as Opex.

Portfolio Team expenses shown in FIG. 9 are also structured in a parent-child relationship. These are the roles within the organization, and, more specifically, the roles within a service portfolio. A typical role, for example, is a service portfolio manager that would have one employee in that role. Other typical roles are architecture, engineering and operations, which could have multiple employees. Each employee would belong to this organizational unit that in the tool is defined as a “role”. An employee is first defined at the company level (role, annualized salary, burden rate, manager, location, capacity in hours, time off) and then “assigned” to one or more of the available service portfolios using a percentage value. By doing this, that percentage value of the employee's expense and capacity has been applied to the service portfolio(s) so that within each of those recipient service portfolios, the employee's expense and capacity can be allocated to one or more of the roles that have been defined for the portfolio. The final step is to allocate that employee, by role, to one of the defined services in that portfolio.

In accordance with the example shown in FIG. 9, this classification system captures 100% of expenses, and if done properly, 100% of capacities in terms of people and service units (e.g. GBs for the storage example) so that the tool of the present invention has everything it needs to calculate this blended unit cost. In and of itself, the blended unit cost is not valuable if the end goal is to achieve a true services base cost model, because a blended cost is similar to the example of a rental car business. If one were to take the high-end cars, mid-range cars and compact cars, and aggregate all their associated expenses, and divide by the total number of cars that are in the fleet, the result would be a cost per unit-vehicle—e.g., a blended cost per car—that would not make much sense and would have little value. What makes more sense is to build out those services levels.

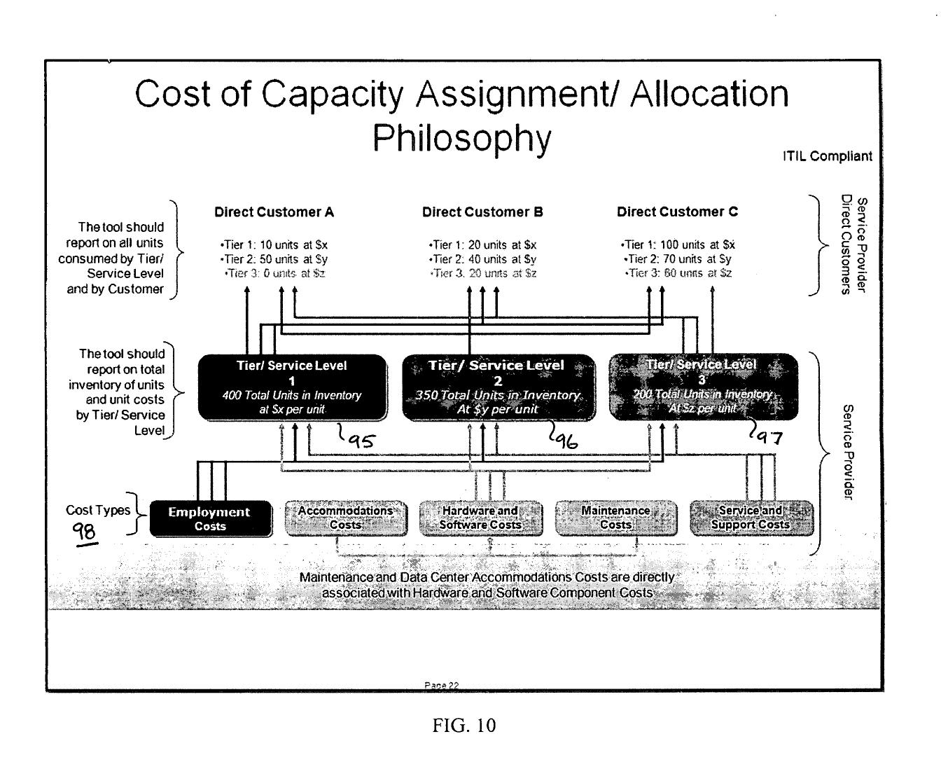

FIG. 10 illustrates all the expenses and capacities from FIG. 9. Utilizing the rental car example, Level 95, 96, 97 are where one would define the kind of luxury vehicle, the mid-size vehicle and the compact vehicle. Service Levels 95, 96, 97 are the service offerings. It is then desirable to associate the cost types 98 with the service offerings, and more importantly, to allocate cost types 98 to supporting these specific service offerings 95, 96, 97. In the rental car example, all cars bought that are associated with, the luxury vehicles and the associated maintenance contracts that are supporting them, including whatever lot cost is required for having them in inventory. And the same thing happens with the mid-size and compact vehicles. But, maybe there is a higher cost to support the luxury fleet rather than the mid-size compact cars. In that instance, it is important to allocate those costs to the proper fleet, including any employment costs that may be required to upkeep one fleet over another. This is an example of shared services. By doing the proper allocations, I can then come up with a unit cost on a service-by-service basis for each service level 95, 96, 97 that reflects true costs and true capacity.

Continuing with the example of FIG. 10, with these services defined and unit cost in place, one may open the door for business and then manage the costs, because, for example, people come and go from an employment perspective and, as the organization makes gains in efficiency, some of the services and support contracts may drop off or, if a new offering is added, maybe the service and support contracts increase. So, this example shows how an organization, and more particularly the associated costs is dynamic in nature. Because these are shared resources across service levels 95, 96, 97, it is desirable to factor that into the ongoing unit price so as not to overcharge or undercharge the customers.

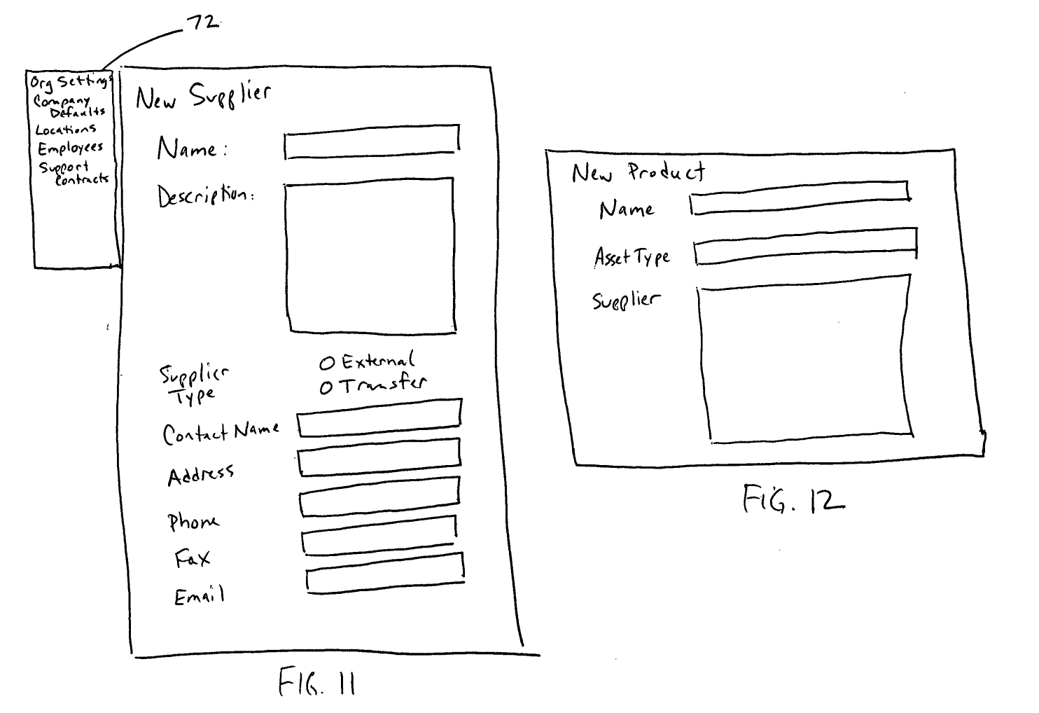

FIG. 11 shows where the suppliers are defined by the user. Very simply, selecting the “Suppliers” hyperlink under External Settings within Settings 72 allows the user to enter information about the supplier. For example a description of the supplier and whether it is an internal or and external supplier including any contact information.

If a supplier data base is available, it is desirable to provide an integration point to pull all supplier information into the tool so a user is not required to reproduce it. FIG. 12 illustrates how a user defines a product after selecting the “Products” hyperlink under External Setting within Settings 72. Every product is associated with an asset cost type,—e.g., is it a hardware or a software product—and a supplier.

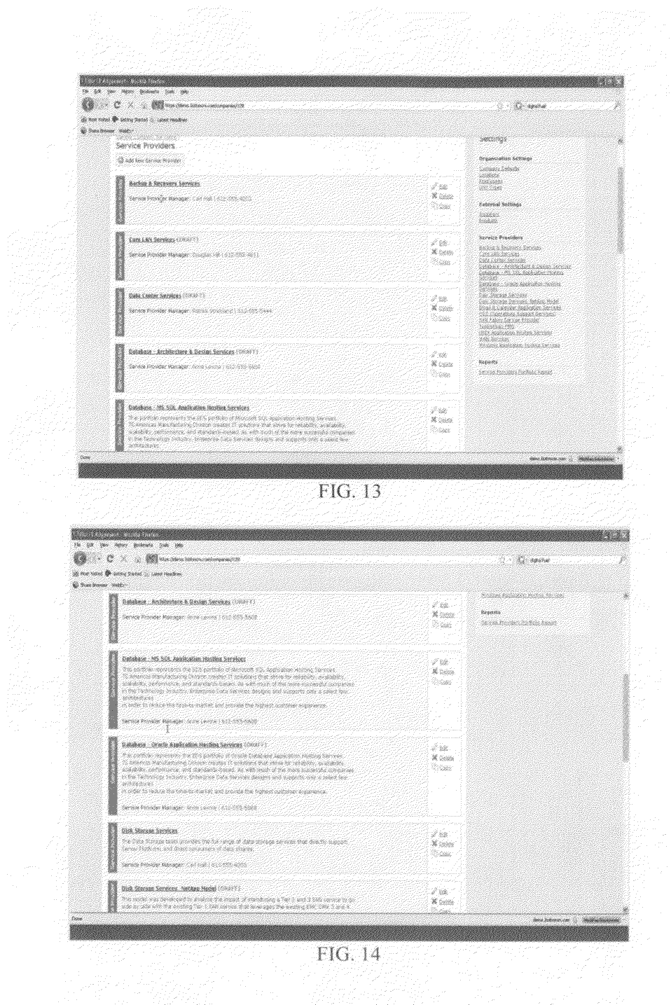

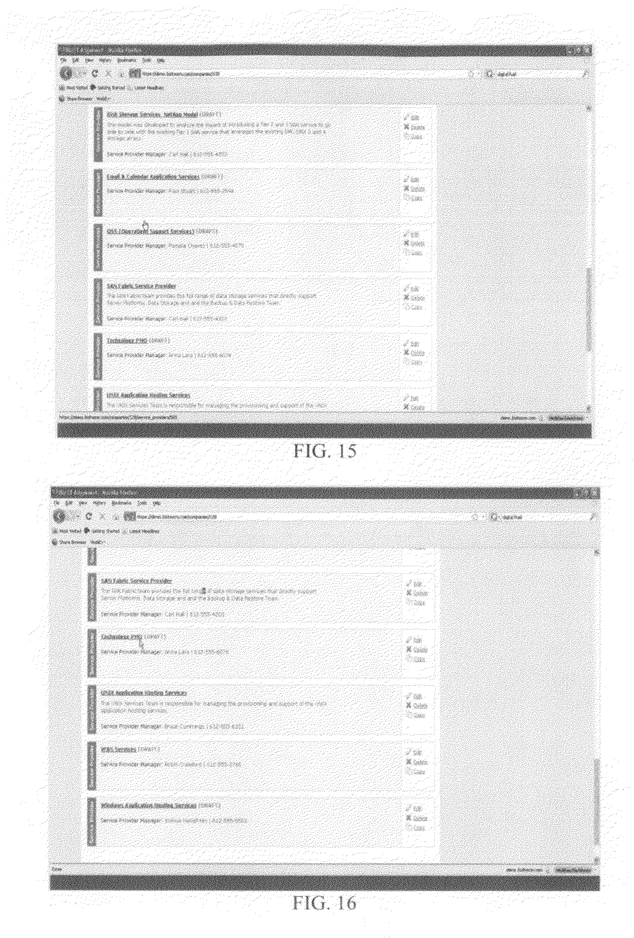

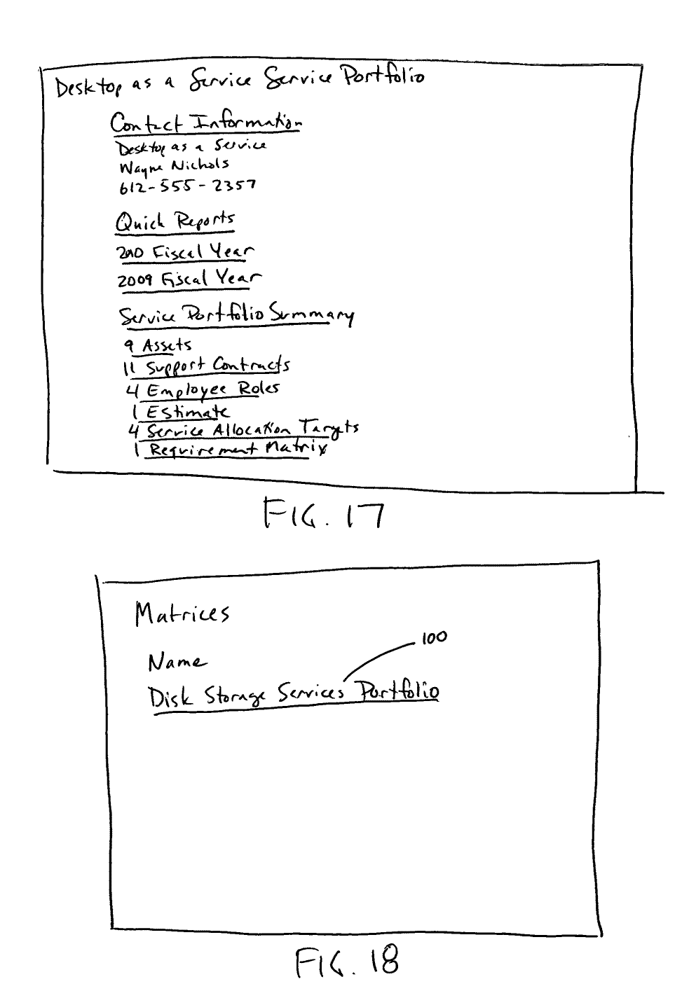

FIGS. 13-16 shows a view of the tool that is the manifestation of that supply chain according to one embodiment of the present invention.—e.g., LAN service portfolios, data center service portfolios, various data base service portfolios. In each one of the service portfolios shown in FIGS. 13-16, a portfolio of services is associated with each particular service portfolio. So, for example, Back-up and Recovery services has a cost per gigabyte backed up; Core LAN Services is the cost per LAN port; Data Center services is cost per kilowatt, or cost per square foot; Database Microsoft Sequel Application Hosting service is a cost per Microsoft sequel data base license; the Oracle Application Hosting service is a cost per Oracle data base license; Disk Storage service is storage cost per gigabyte; OSS is a cost per monitored object; SAN Fabric service portfolio is per SAN Fabric port; Technology PMO may have a cost per an hourly rate for the project managers that get pulled in to manage projects internally, or it may be a cost per project if there is fixed-fee types of projects with a predictable and well-defined scope. Units Application Hosting service is a cost per processing unit; LAN services cost per megabyte or gigabyte per second peak; and Windows Application Hosting services is a cost per server.

So, for each of the examples of FIGS. 13-16, a lot of what determines when a function should be broken apart within an organization into service portfolios is when the unit type logically does not make sense to stay combined. For example, in the storage IT function, Carl manages that function, and, in the storage function, belongs to back-up and recovery; he also belongs to the Disk Storage services; and SAN Fabric is also managed by Carl. So, functionally, all three belong in the organizational unit called Storage, but, there are three different service portfolios in the illustrated example that are broken out separately in order to manage to a consumption based model with unique unit types.

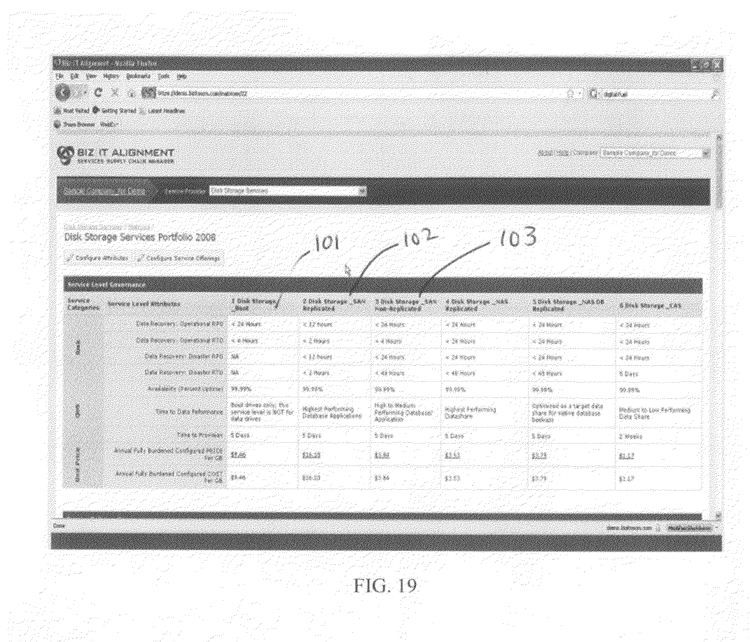

FIG. 17 illustrates Disk Storage Services in accordance with the present embodiment. Now, before the explanation of costs and the capacities in accordance with the present invention can be discussed, it should be understood that a lot of IT organizations do not have their services or service portfolios defined.

So, to ask an IT Organization to go create what those services are or look like, for example, in the rental car analogy, the Organization does not have the “luxury”, “mid-size” and “compact” defined yet. So, it is desirable to create the services first before doing any of the services costing in accordance with the present invention.

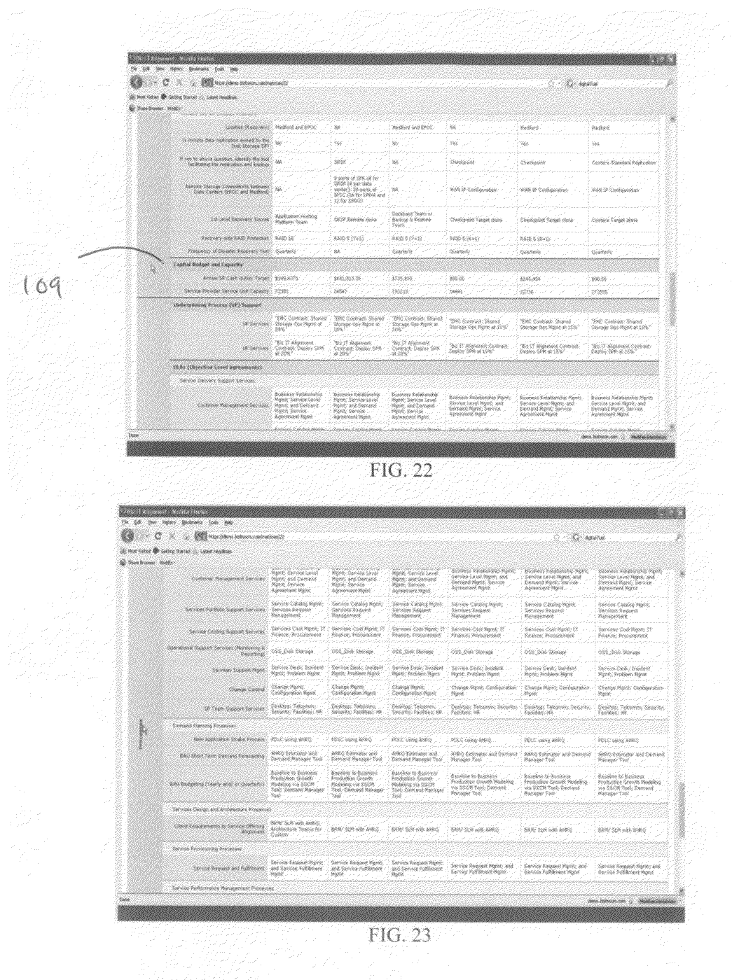

FIG. 18 shows a tool referred to herein as the Portfolio Requirements Matrix. In the example shown and described, the Disk Storage Service Portfolio 100 is selected. As shown in FIGS. 19-24, the resulting matrix gives the user a structured framework to operate within. As illustrated, there are two parts to the matrix: the top half, which is the Service Level Requirements , and the bottom half, which is the Service Delivery/Functional Requirements. And Service Delivery Requirements are effectively rationalized by the outcomes in the Service Level Requirements portion of the model. Each column with the Service Level Attributes 105 is a service. So, analogizing to the rental car example, Disk Storage Boot 101 would be similar to a luxury car. Disk Storage_SAN Replication 102 would be similar to a mid-size car, and Disk Storage_SAN Non-Replicated 103 would be similar to a compact car. Obviously, it is not as simple in the illustrated example of FIGS. 19-24. But, the illustrated example and the rental car example are both concerned with defining the attributes that customers care about. If a customer wants some storage in the illustrated example it may be desirable or necessary to understand the differences among SAN, NAS, CAS, DAS, etc. The user just needs to have a certain level of recoverability for day-to-day operations and a certain level of recoverability in the event of a disaster. It may also be desirable to know what level of availability of percent up-time to expect and what the relative performance is currently operating. The user may also want to know how long it takes to provision once a service is requested. The user may also want to know what the price is for the different options out here. So, remembering that the value is not just the best of everything; the value is having a full range of options to meet relatively different needs. The user asks the questions: who owns this disk storage service portfolio and who are the customers.

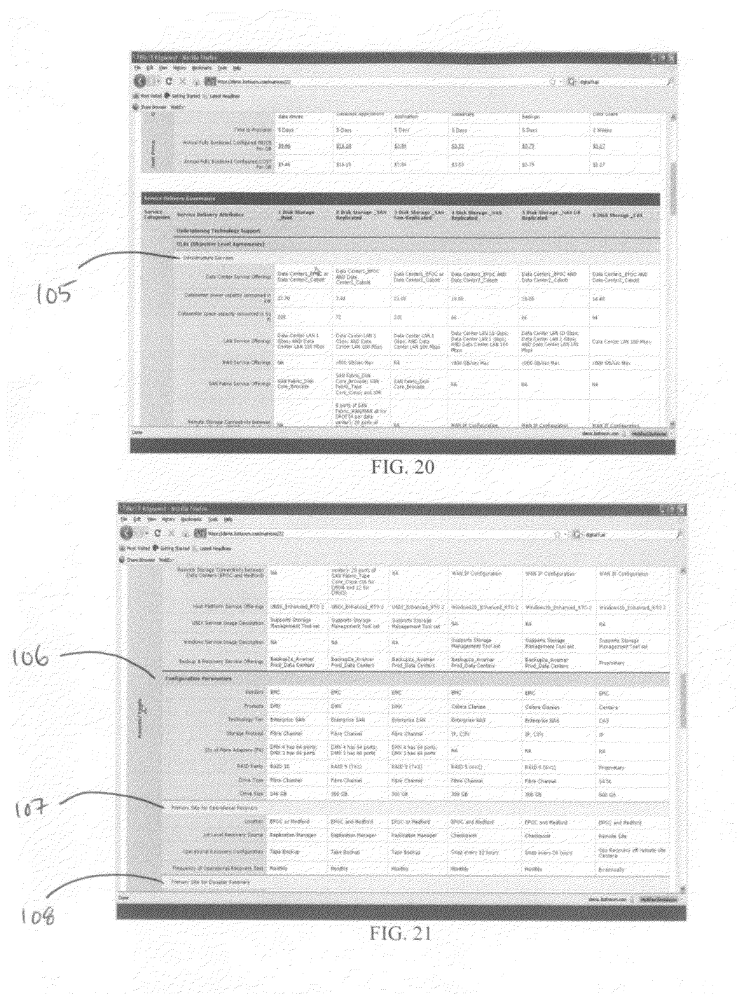

So, for example, the Disk Storage Boot 101—someone might look at that service and state “I'm an end user and I have no idea what that means”. Typically, that's because this particular service would never be made available to certain users in a service catalog. Access would be restricted to the host platform team, i.e., the only users who are going to buy these types of services. Same thing occurs with Disk Storage_SAN Replicated 102 and Disk Storage_SAN Non-Replicated 103. The only direct buyers of those services are going to be the platform teams, like the UNIX team or the Windows team. But, services like NAS and CAS are definitely services that are purchased by an end user or different organizations, so, maybe risk management or legal might be interested in this service. But, Service Level Attributes 105 are all about outcomes, and they are not about how it is done. But if you go to the engineering team—the service delivery team who is responsible for delivering these services—and provide them with the specs which basically are, how to architect it. The bottom half illustrated in FIGS. 20-24 is the “how” associated with the “what” of the upper half illustrated in FIG. 19: you need assets and tools and processes to support and to make those assets and tools work appropriately. The “how” also includes team allocations consisting of capacity of people hours. It's either employees only, or it's a combination of employees and contractors. This links back to the other services costs including what has been discussed previously.

Now, for each one of the categories shown in the bottom half illustrated in FIGS. 20-24 there are various attributes that are specific to this particular service portfolio's way of managing their business or managing service delivery. So, in other words, if the top half in FIG. 19 defines the “what” to hit certain service level targets relative to quality of service and risk, the bottom half illustrated in FIGS. 20-24 is how to do it. For example, and in no way limiting, the organization needs to buy this stuff shown in Infrastructure Services 105, it must be configured like this shown in Configuration Parameters 106, making sure that certain things in various locations are in place for operational recovery and for disaster recovery as shown in Primary Site for Operational Recovery 107 and Disaster Recovery 108, operating within a cash budget shown in Capital Budget and Capacity 108 based upon this much capacity and the Organization should expect to spend x dollars based on demand. There are also processes associated with the “how.” For example, the difference may be a fixed-fee project that needs to be in place so that the maturity of operation is at a level to reliably meet the targets shown in FIG. 19. There are additional processes, for example, who are the internal OLAs that need to be in place or internal suppliers. The processes ultimately fulfill the various types of attributes. Essentially, these are pointers—direct links from the services costing tool to reduce or even eliminate doing double entry or duplicated entry, so everything is reconciled. Importantly, the tool suite of the present invention is integrated for that purpose.

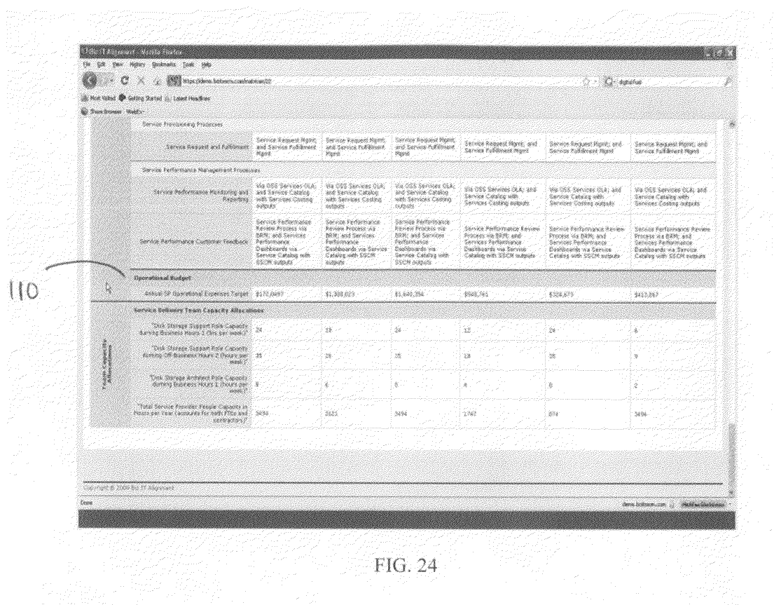

As shown in FIG. 24, for each service the operational budget 110 is provided. FIG. 24 also shows what the results are in terms of the number of hours capacity, but typically does not factor in executive management overhead hours. The capacities shown are hours of the individuals that are designed to support the services to get an idea of the split-out in terms of their capacity. Why is that important? Because that drives the percent allocation of those shared resources to these specific services so that the tool can cost them appropriately.

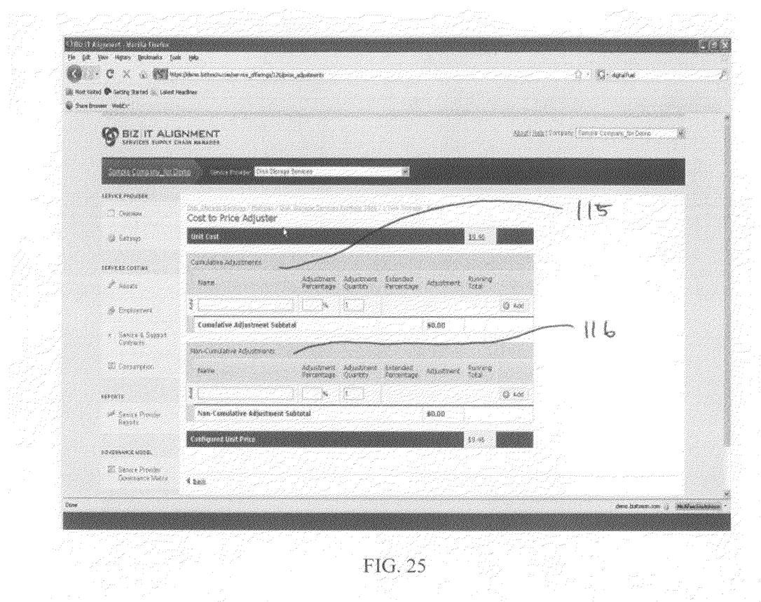

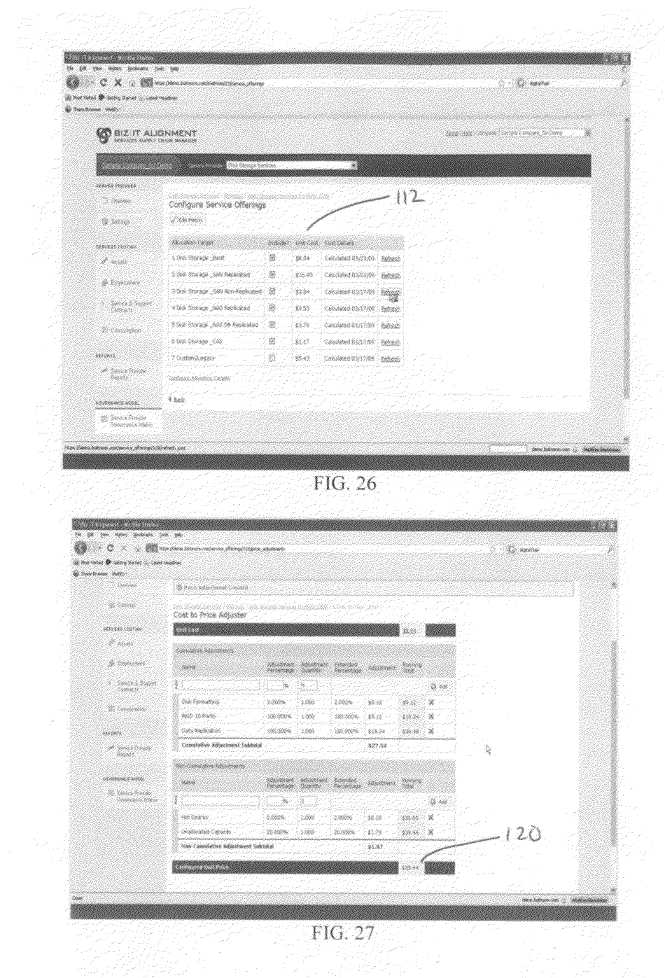

So, by performing the extensive “how” in FIGS. 20-24 for each one of the services 105, the cost drivers and the capacity are captured in FIGS. 20-24 such that the raw unit costs may be calculated. This is only the raw unit cost to unit price; adjustments are then typically made. Selecting the unit cost link 111 in FIG. 19, takes the user to the Cost to Price Adjuster illustrated in FIG. 25. As shown in FIG. 26, selecting the “refresh” links updates the unit costs 112 from the services costing tool. So, refreshing updates the unit costs 112 with the current unit costs.

FIG. 25 illustrates how a user can make adjustments to the unit cost 111. In the illustrated example, the tool provides for cumulative adjustments 115 and non-cumulative adjustments 116. Adjustments are defined herein as cost to price. Adjustments may be uplifts or discounts. The tool is configured to account for both.

FIG. 27 illustrates an example of a non-cumulative upgrade or up-lift to the unit cost 111. One adjustment is shown as a “Hot Spare” that equates to 2% of overhead for an up-lift of 18 cents to the unit cost 111. So if the $8.94 unit cost represents a single unit, and the “Hot Spare” is a 2% overhead for a single unit, then it just takes 2% of the single unit cost for an uplift of $0.18. Unallocated capacity is also shown in FIG. 27. If the organization operates in a zero sum game model where it has to recover everything, in this particular case, 20% of inventory at the end of the fiscal year here that is going to be unallocated. Unallocated capacity is to be factored into unit price. Otherwise, a variance is required at the end of the year. So, rather than do that, in the illustrated example, unit price is going to account for unallocated capacity from the get-go.

Cumulative adjustments shown in FIG. 27 are for situations where order matters. So, in the illustrated example, Disk formatting, which is a 2% overhead, has to happen first. Continuing with the illustrated example, RAID parity which has 100% overhead, that means for every disk that is usable, there has to be another disk available for data protection.

Continuing with the example shown in FIG. 27, Data Replication is allocated at 100%, which is going to be replicated to the remote site. So, by doing this, since order matters for cumulative adjustments, the adjustment for RAID 10 occurs after the adjustment for disk formatting has been calculated and added to the unit cost. Data replication occurs after the adjacent for RAID 10 has been calculated and added to the unit cost. So that it calculates appropriately in the proper order using the correct running total of unit cost. Each adjustment is added to the base unit cost, to arrive at the configured unit price 120. The same calculation is performed across the board.

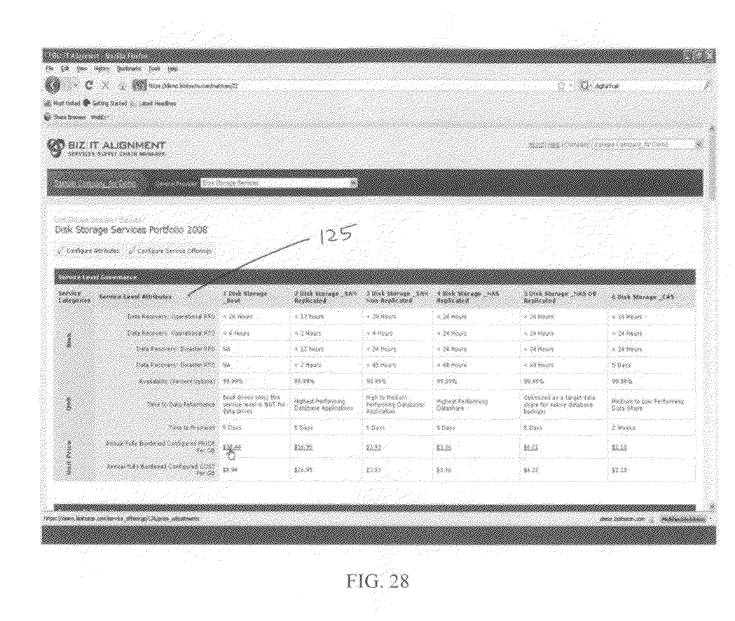

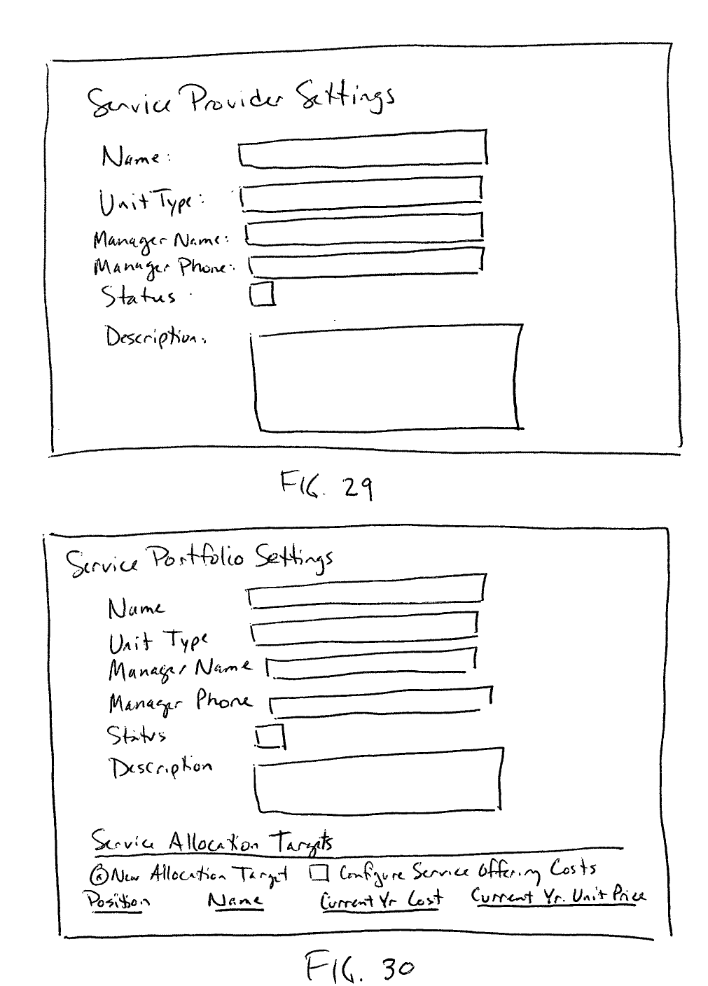

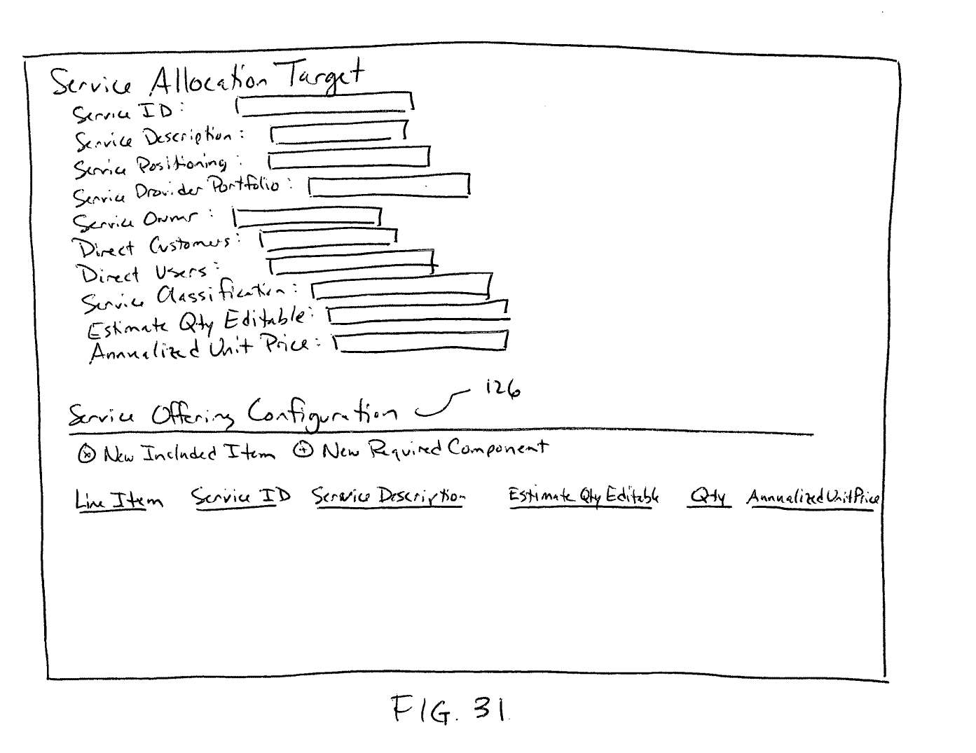

The service portfolio requirements matrix is important to help understand the identity and value of what tools, assets, processing and people, since each Service Level Attribute 125 of FIG. 28 is a cost driver defining services/allocation targets for costing. The Service Portfolio Requirements matrix also defines what should be feeding costs and capacity, as shown in FIG. 10. Employment costs, accommodations costs, all the items on the bottom half of the matrix are the various components. The bottom half illustrated in FIGS. 20-24 is all about service delivery. The matrix creates a common way across all the service portfolios across an entire organization to ensure that they are managing the same way.

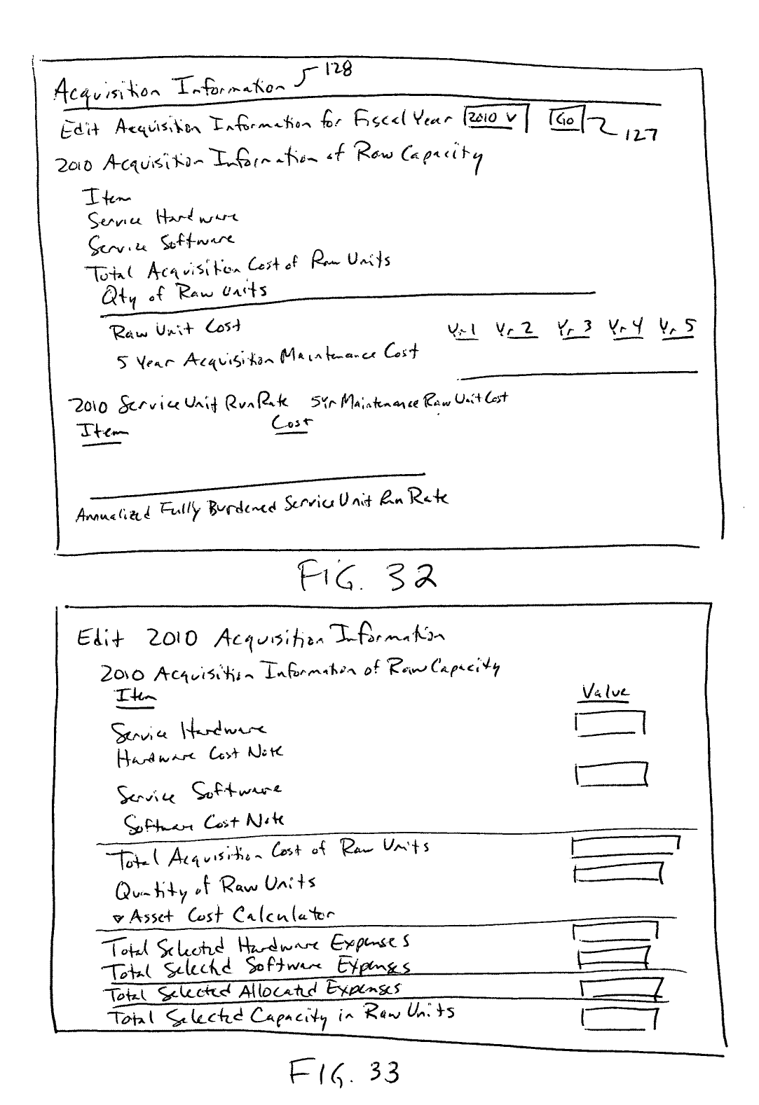

FIG. 29 shows the input screen for Disk Storage Services to set up and define various attributes such as name, unit type, the manager name, the manager's phone number, the status as a draft and the description to name a few. The definition is critical because, once it's defined, the tool looks for any capacity that's defined—in this case, gigabytes. The tool searches for the match for the disk storage, service portfolio's unit type. And that's how the tool calculates capacity. FIG. 30 illustrates the portion of the Service Portfolio Settings input screen for defining the services/allocation targets. The services/allocation targets in FIG. 30 are the same services that are represented in the columns of the service portfolio requirements matrix. This view shows the list of the services within the portfolio along with “Current Yr Unit Cost” and “Current Yr Unit Price”. The tool states “Current Yr” because if a service has been in existence prior to the existing year, it is likely that its unit cost and price were different than in the current year. That is why the explicit label of “Current Yr . . . ”

By selecting any one of the Services seen in FIG. 30, the user is taken into the following “Service Allocation Target” page as shown in FIG. 31. This page shows information about the service and reference points that the tool draws upon for reporting and analytics.

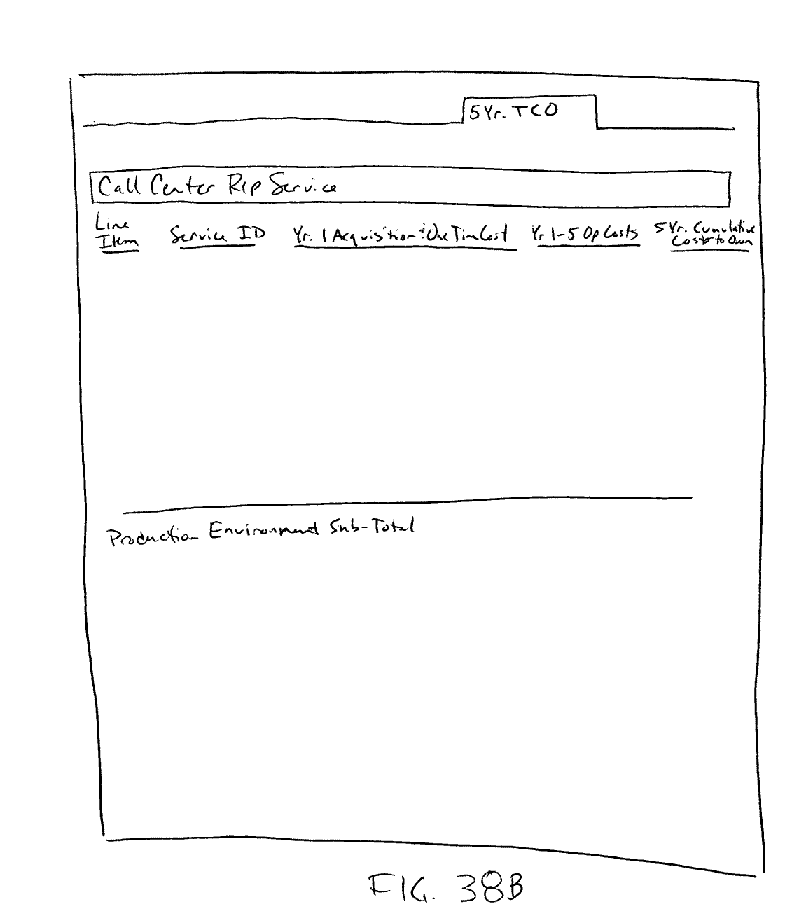

In the illustrated example of FIG. 31, there are three tabs. FIG. 31 shows the first tab “Service Offering Configuration” as active. This is where the service owners build out the full service with other service components, set the quantities for each component as well as whether that quantity should be editable in the estimate or not (determines variable pricing or fixed for the configuration). By doing this the service is owner is able to control a predictable outcome for a service offering while also providing complete transparency into the line items that make up the service offering along with their description and price. It is this build that the SPM Estimator (referred to in FIGS. 36-39 herein) pulls from any time anyone goes to build out a BOM (bill of materials-like) estimate. And when any service owner updates any aspect of their service, it automatically perpetuates to every service that has selected it as a service component.

As FIG. 32 below shows, the second tab is currently referred to the “Acquisition Information” tab. This page is how the service costing, pricing and acquisition information is both set up and viewed. It is the reference point that provides the rationale behind the service's unit cost and unit price. It is where the capital asset components and associated capacity (capacity only if it is a factor for calculating unit acquisition cost) is configured and then viewed. It is where the maintenance contract information by year purchased (not realized—that is the Opex value) that is associated with the asset components described above is configured and viewed. It is where any accommodations costs that are attributed to the pre-identified asset components are viewed (they are automatically applied when the component has been selected for the service). It is where the Capex services are applied and then viewed. It is where Opex support expenses (less depreciation and amortization) are applied and viewed—specifically employment expenses and Opex based contract expenses (both internal and external).

All of these are selectable through the “Calculator” once the user clicks on the “Go” button 127 that can be seen in FIG. 32.

Once the “Go” button 127 has been selected the SPM tool takes the user to the “Acquisition Information” page 128 in which the parameters described in the paragraph above are set.

FIG. 33 illustrates a window for selecting the parameters are selected specific to the service's asset component(s), maintenance contract expenses, accommodation expenses, Capex contract expenses, employee expenses, and support contract expenses. The user is required to go into what is now called the “. . . Cost Calculator” in which the user will see only those resources that are in that “Selector's” category (e.g. Asset Resource Selector; or Capex Contract Selector; or Employment Expense Selector; or Opex Support Contract Selector). And the user will only see resources in each category that have been input into this service's portfolio and allocated to this service. That way, the list does not get unruly making this process extremely efficient, controlled and intuitive.

The tool within FIG. 33 provides a translation between year 1 acquisition unit costs and annualized run rate unit costs. In order to do that, any Capital expenses (assets, pre-paid contracts and service contracts) must be broken out into their depreciation and amortization schedules (e.g. asset ABC is depreciated over 5 years; Design and Deploy service contract is amortized over 4 years; etc). In addition to this, all Opex is applied to the already identified number of raw units acquired, so that the fully burdened annualized unit cost can be calculated.

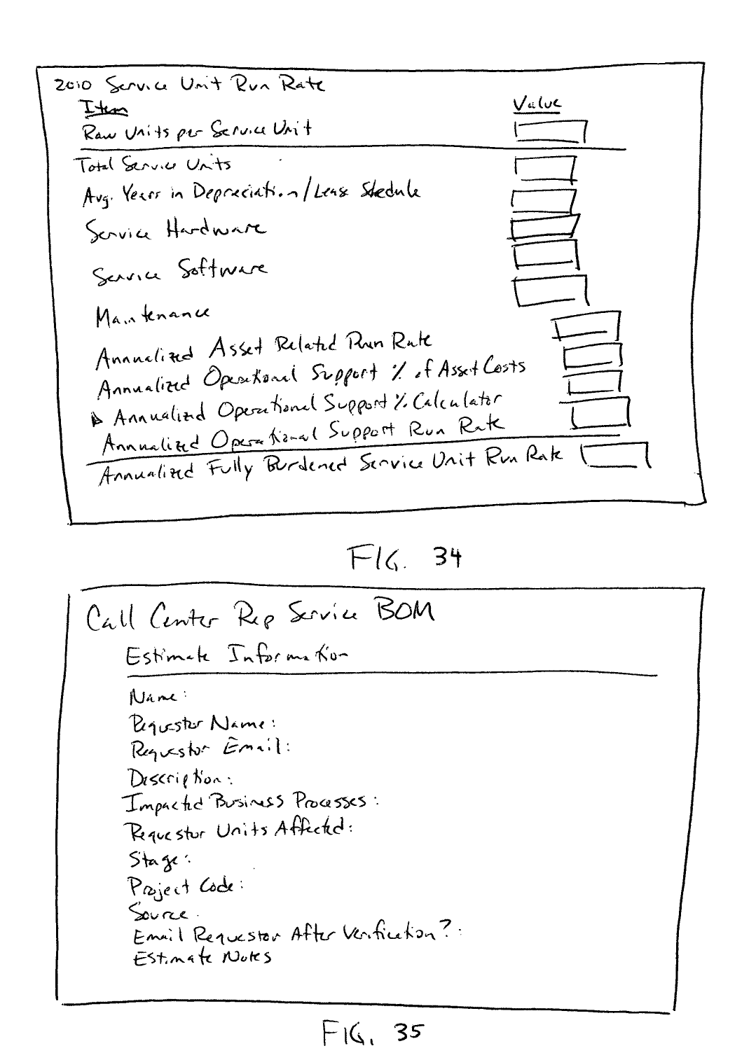

The final treatment available here is an adjustment, if any, from cost to price. The tool automatically provides the calculated value between the service's unit cost and unit price as it is pulled from the “Cost to Price Adjuster” module. And there is a link that takes the user directly to the cost to price worksheet for the service in the event that the user wants a closer look or the ability to modify if they have that permission available to them. FIG. 34 provides some visibility into what is described in this paragraph.

Because this is modeled based on a sampling of the raw materials that constitute cost and capacity, this unit cost and unit price may be different than the “actual” unit cost calculations that may take into account all the resources that are employed in the environment today. This ability to see actual against the ideal is extremely valuable for showing today's actual degree of inefficiency compared to what net new would look like.

This tab's information is the source data for the Estimator module's TCO and Year 1 Investment calculations that are visible on the Estimator's respective tab views. The Estimator and its relationship to this source data will be described in the following paragraphs.

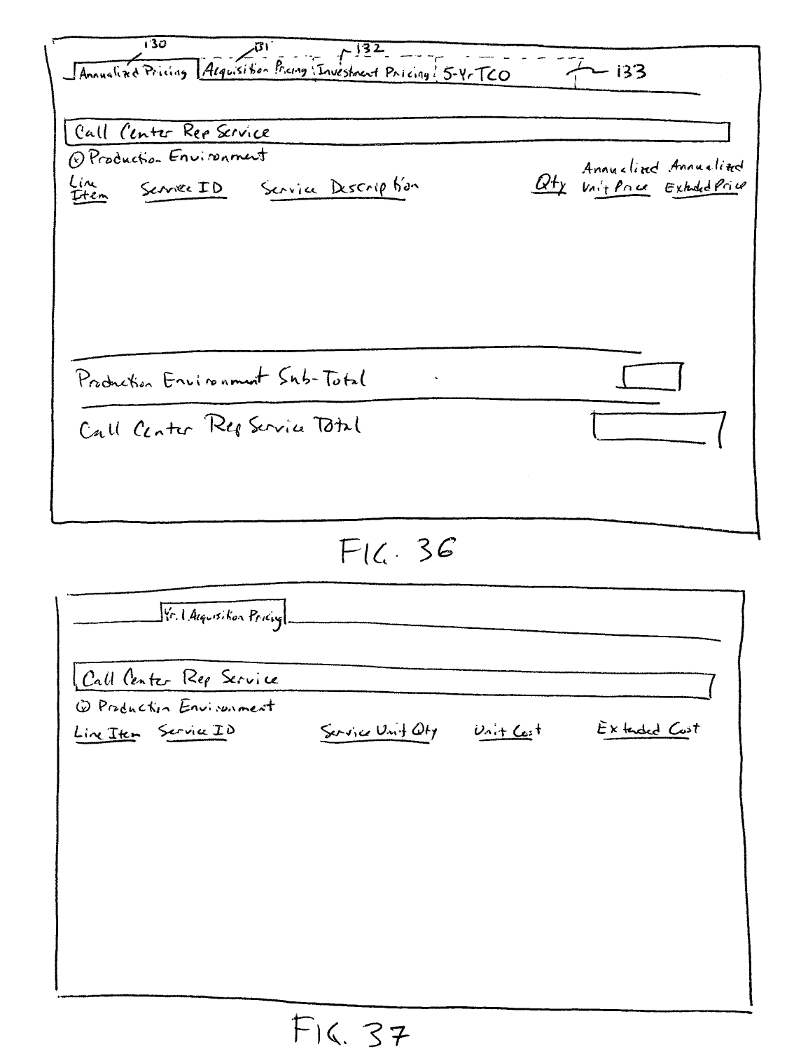

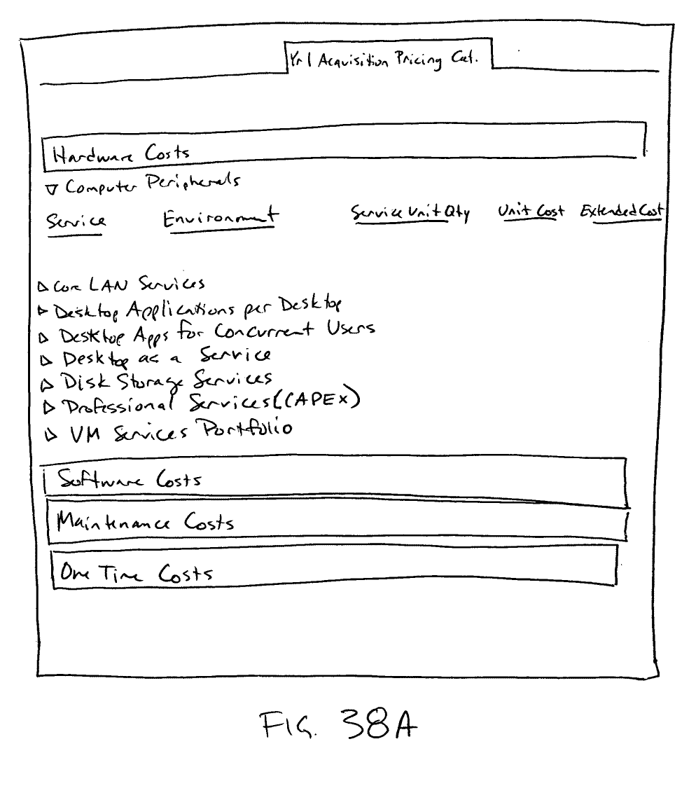

Within the SPM Tool there is the Estimator Module as seen in FIG. 35. This module provides users the capability of building and viewing service offering/service bundle BOM (bill of materials) estimates view for the purpose of analysis, modeling and/or rationalization.

As FIG. 36 shows, there are four tabs at the top of the page 130, 131, 132, 133 that represent the four views in which an estimate can be viewed. The view in FIG. 36 shows the annualized pricing for the service configuration in this case entitled “Call Center Rep Service”. The annualized pricing 130 takes into account annualized unit prices for each service based on the existing fiscal year and uses depreciation and amortization expenses, thus there is no capex factored into this estimate view.

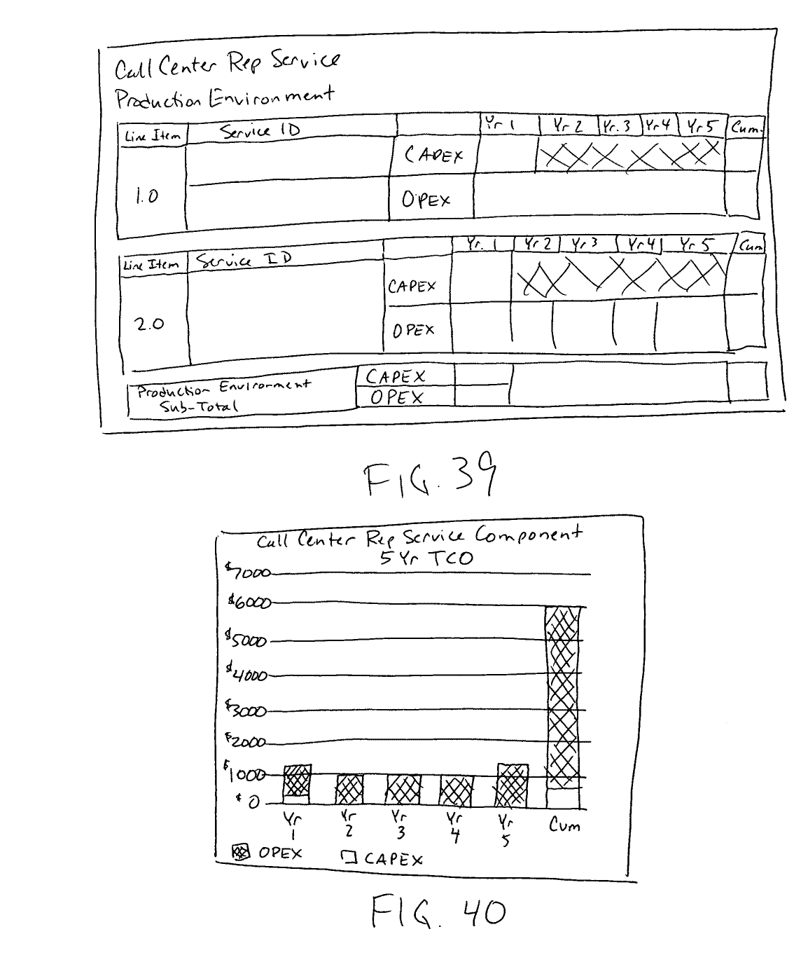

The second tab is the Year 1 Acquisition Pricing 131. This estimate view tab, as shown in FIG. 37, also shows line item pricing in the same order as the tab one view 130, but for each service the tool shows the breakdown of the year 1 investment which equates to Capex or cash outflow. It shows the hardware, software, pre-paid maintenance, and it will show any one-time service contract expenses that qualify as capex. These values are pulled from the “Acquisition Information” tab described above and represented in FIGS. 32-34. This view currently displays the “Post Year 1 maintenance costs but that will be removed and applied to the 5 year TCO tab 133 that will be described in the paragraph to follow. As the FIG. 37 also shows, each line item has its own roll up to extended cost as well as a rollup total for the “Production Environment”; and in the event that there are multiple Environments and/or Tiers there are roll up sub totals and overall estimate totals as well.

Tab three “Yr 1 Investment Pricing Categorized” as seen in FIG. 38, provides the same information that is in tab two but instead of viewing it by line item, this view provides a view that is categorized by Hardware, Software, Pre-paid Maintenance, and One-Time Service Costs. And below each of those categories are the services categorized by the service portfolios to which they belong. This view is very beneficial and efficient to project managers and finance teams who collectively build out project Proformas using these categories and corresponding subtotals for their project accounting. The blue arrow heads to the left of each category provides the user the ability to expand and collapse estimate detail on the fly. SPM also provides an “Export” button for exporting the fully collapsed and formatted report into Microsoft Excel.

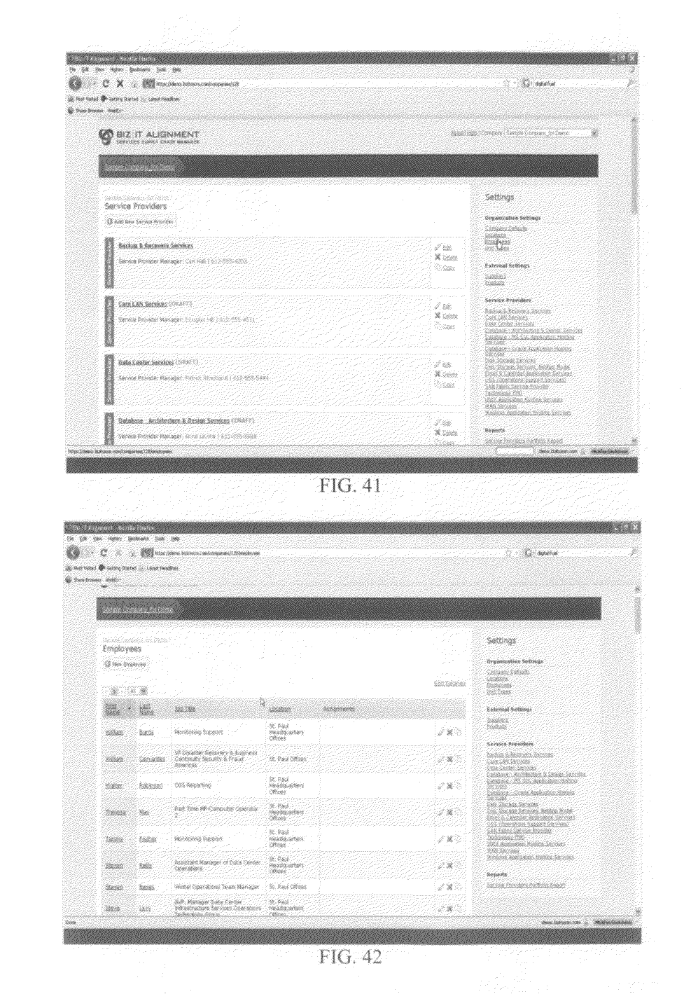

The fourth tab entitled “5 Year TCO” 133 as seen in FIG. 39, is the line item view of the estimate that like tabs one and two, show each service in the same line item order with extended costs, subtotals and estimate roll up totals. The objective of this estimate view is to see the true cost to manage the service offering/bundle over the extended period of five years with granularity at the service component level.

FIG. 39 shows the prototype for the updated version of tab four “5 Year TCO” 133. This view shows and clearly explains that the overall year 1 investment as capex and all opex costs as not including depreciation or amortization so as not to double count asset expenses. By showing each of the five years it allows for variability of Opex in any of the yearly periods as is shown in the example below where in year 5 for both services there is a jump in cost due to the need to purchase an extended maintenance contract for an asset component that was purchased in year 1.

FIG. 40 provides an example bar chart that can be generated as an extension to the 5 year TCO estimate view.

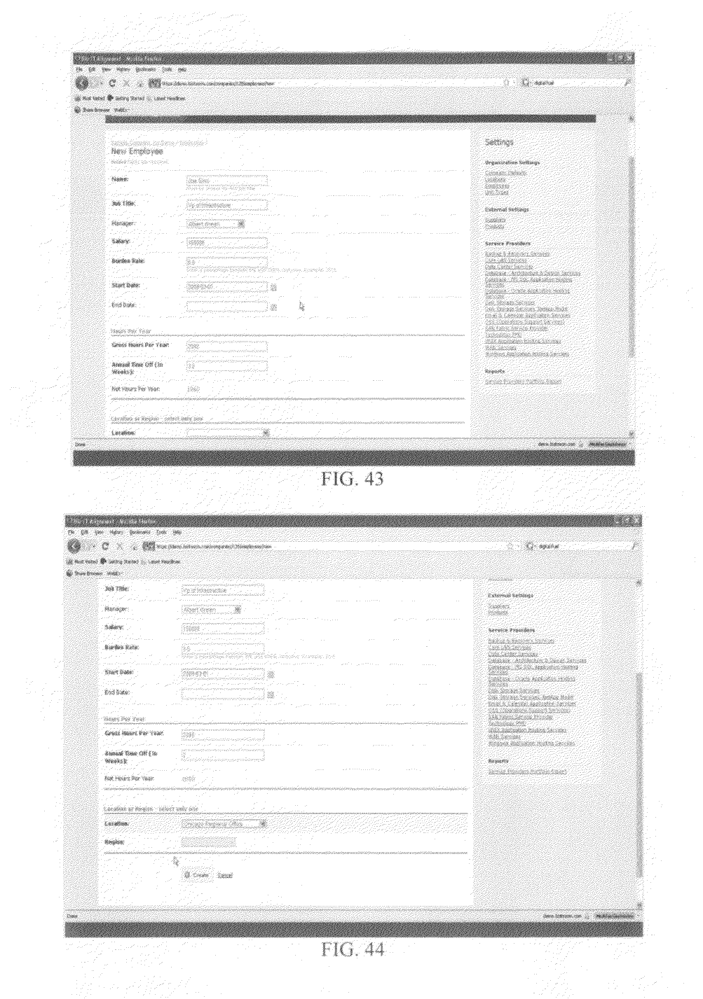

FIG. 41 illustrates employment at the service portfolio level. Selecting the “Employees” link from the Organizational Settings within the Settings 72 brings up the view from the company perspective. FIG. 42 illustrates the company's settings for this entire organization to understand who the employees are. The tool of present invention is configured to have the flexibility to integrate in with an HR-type of tool like a People soft, and then do mapping and pull over the pertinent information. In essence, there is a table of all the different employees of the organization that are relevant for the tool. In one example there are different sorting options available by selecting the column heading, such as Last Name, Location or Job Title to name a few. FIGS. 43 and 44 show the page for entering a New Employee into the system. In the illustrated example, Joe Smo is entered including his title of VP of infrastructure. Joe's title is not necessarily his role within the organization, because, as seen in later examples, the VP of infrastructure may have multiple roles. The employee may have a role within the server team, the storage team, data center, mainframe, etc. Next, the user defines who the manager of this particular individual is, and by doing that, the user is establishing a hierarchy that builds permissions on. So, in this case, for Joe Smo nobody can edit, enter or even view Joe's salary unless you happen to be his manager or Albert Green's manager. The tool of the present invention factors in a start date and an net end date. In the present invention, start dates and end dates are very, very important. Because this is where the tool extends beyond the capabilities of a simple spreadsheet document, because it allows a user to fluctuate and make changes in terms of allocations or roles while still preserving the historical data, which is critical on any type of analytical tool. As shown in FIG. 44, that default in terms of gross hours is 2080, with three weeks off, which nets the amount of hours at 1960 or for two weeks off, it would be 2,000 hours. This person is in the regional office and the user would create Joe Smo.

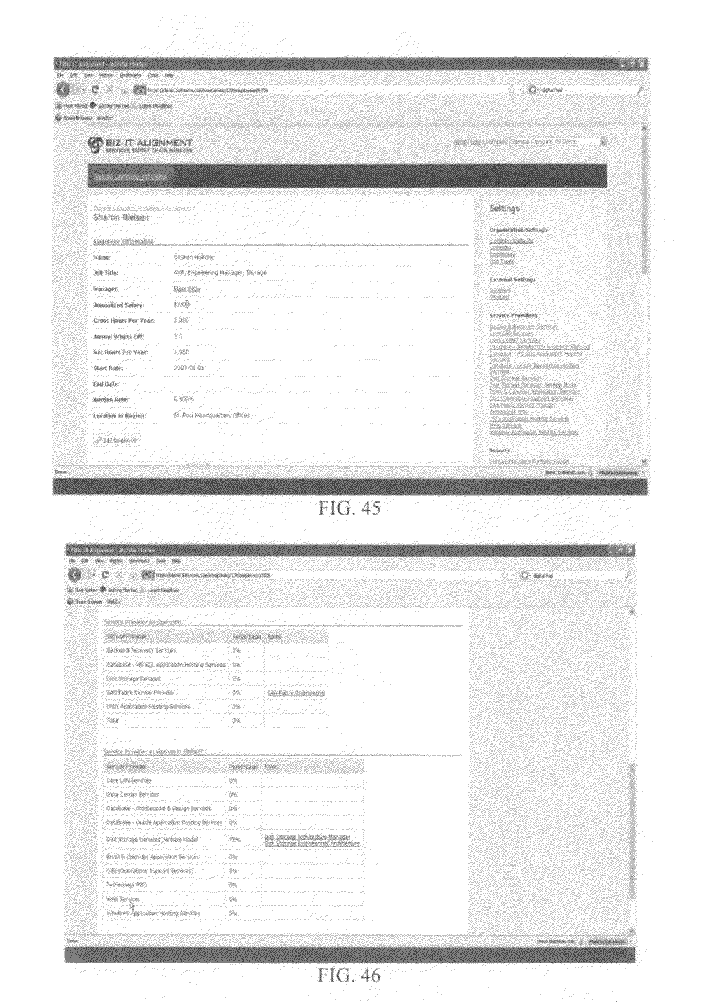

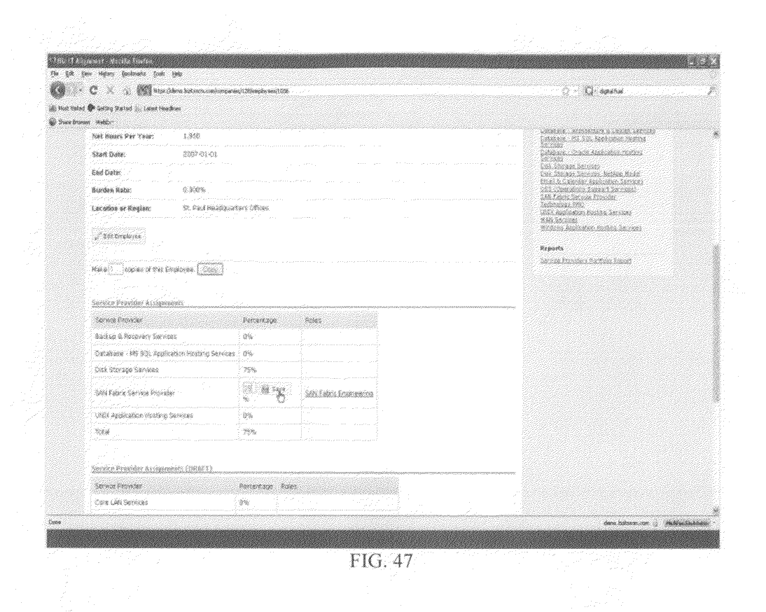

FIG. 45 shows the information for one of the employees in the storage area, Sharon Nielsen. As shown in the example, her manager is Mary Kirby, and the salary is hidden since the user does not have the requisite level to view her salary; it is encrypted, but it's still there. FIG. 46 illustrates the lower portion of the input screen in FIG. 45, and shows the service portfolios that are in production 130, and those that are not yet out of the draft mode and into production 131. How does a user allocate this person's time in accordance with the present invention? So, in this role, as shown in FIG. 47, Sharon happens to spend 75% of her time, or this is what she was hired to do, to support the Disk storage services, and the other 25% to support the SAN Fabric service portfolio. The user specifies this particular allocation of her time. She lives in the organizational function of storage, however her available 1960 hours is split up among the service portfolios within that storage function using the percentages specified. Accordingly, 75% of her salary is allocated to the Disk storage service portfolio and 25% is allocated to the SAN Fabric service portfolio. She is already allocated to this role of SAN Fabric engineering for the 25% allocated to SAN Fabric service portfolio, however, nothing for the 75% allocated to Disk storage services. This example has viewed employees at the company level or organizational level, the following views their information from the service portfolio level.

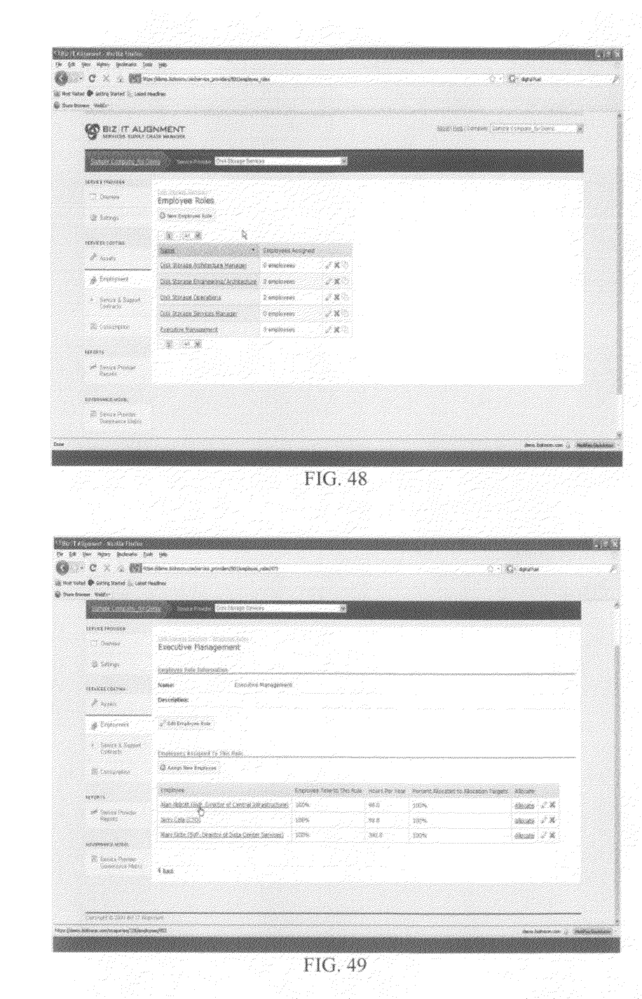

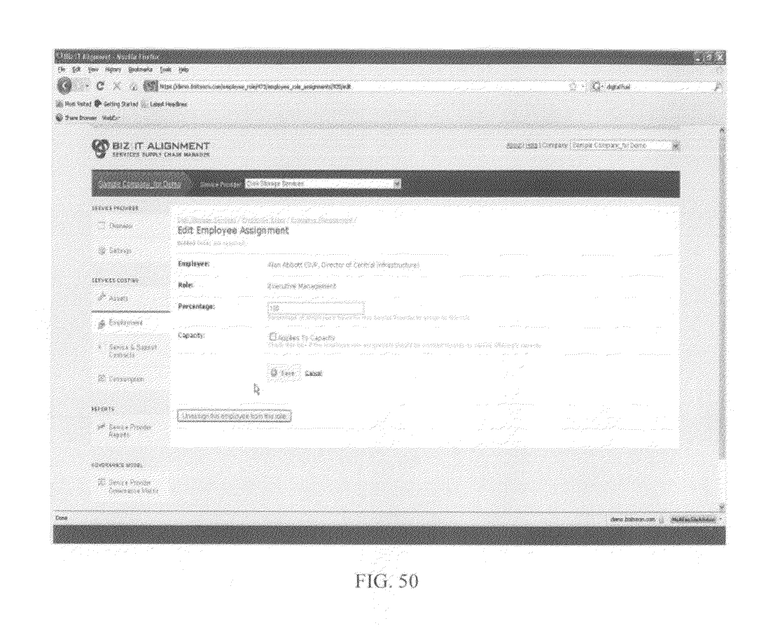

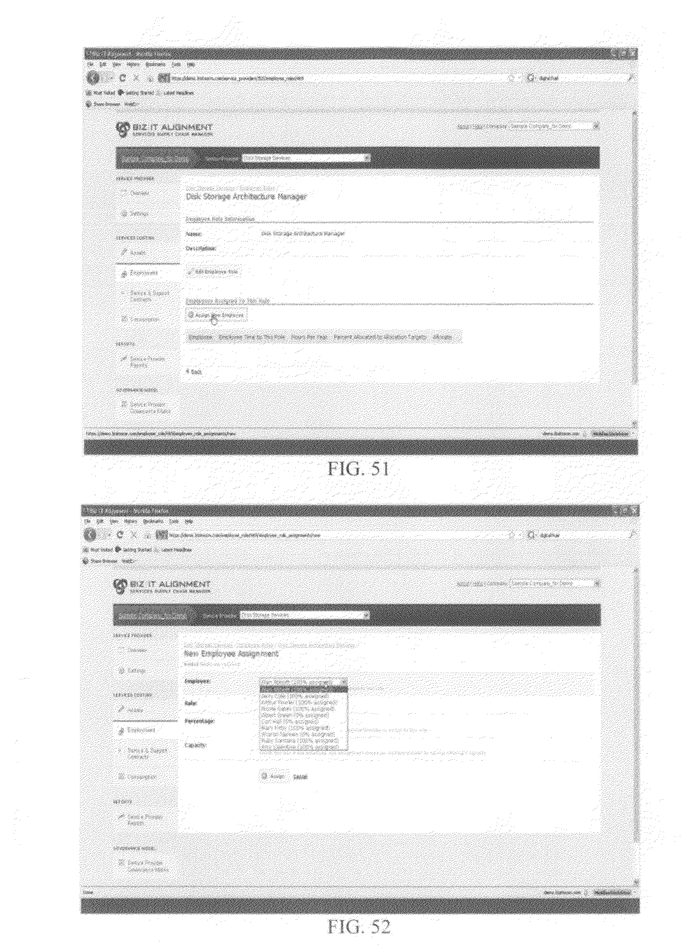

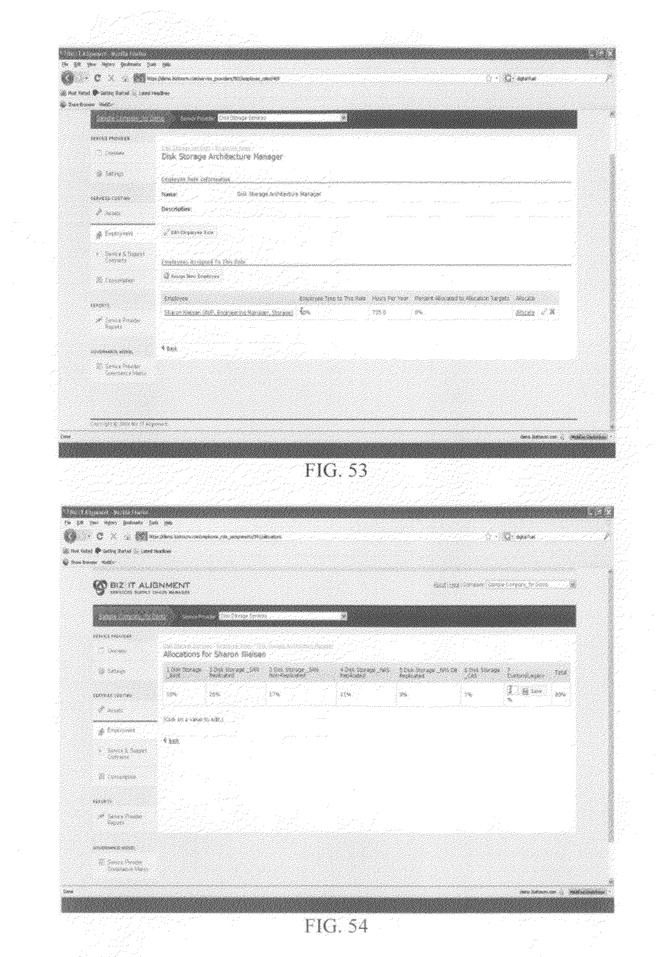

FIG. 48 illustrates the roles of 135, 136, 137, 138, 139 associated with the Disk storage service portfolios, and they can be unique for each one of them. There will probably be executive management 139 for all of them, as shown in FIG. 49, that are going to be the overhead people. In the illustrated example, selecting Allen Abbott generates the screen shown in FIG. 50. As shown, 100% of whatever time was assigned in this capacity will be put into this kind of overhead role. As illustrated, “Applies to Capacity” is not checked; the reason being is there is no capacity in terms of supporting any service delivery directly. Allen's is purely an overhead role. In contrast, as shown in FIG. 51 the disc storage architecture manager has not had an employee assigned to this role yet. FIG. 52 illustrates how to assign Sharon Nielson to the Disk Storage Architecture Manager role. As shown in list 140 it has to be an employee that has already been allocated as in a step before and cannot be entered free-form. As shown, Sharon is 0% assigned. Sharon actually has two roles. Here, 50% of her time is spent being the manager of the engineering and architecture group within the Disk Storage. Since the role is a management role, none of her time to be applied to capacity. She is just assigned without checking the box “Applies to Capacity.” With that, she is assigned. Referring to the example in FIG. 53, Sharon's time is now allocated to the various services using the allocate link 141. So Sharon has been assigned her to this specific role, but time or expense associated with her have yet to be allocated to the services that have been defined—e.g., Dist Storage_Boot, Disk Storage_SAN Replicated, Disk Storage_SAN Non-Replicated, Disk Storage_NAS Replicated, NAS DB Replicated, Disk Storage_CAS and Custom Legacy. So, to do that, the user enters the % allocations so that the total allocated time is equal to 100%, as shown in FIG. 54.

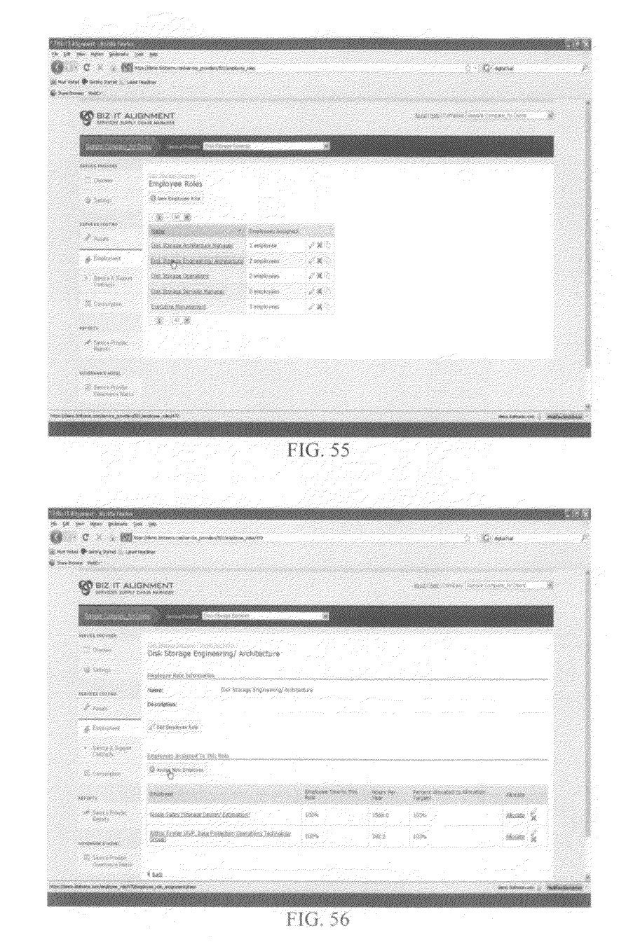

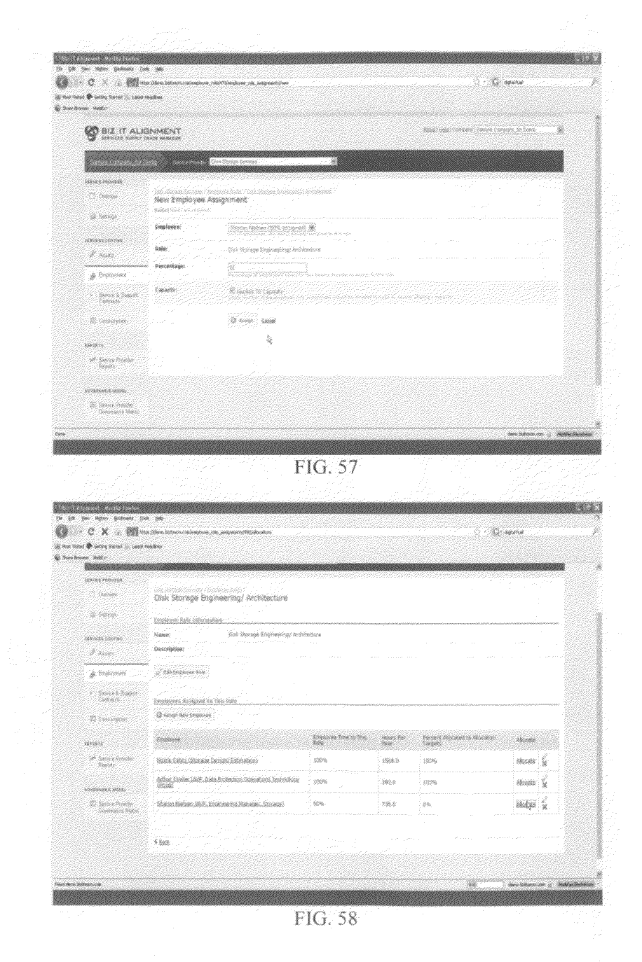

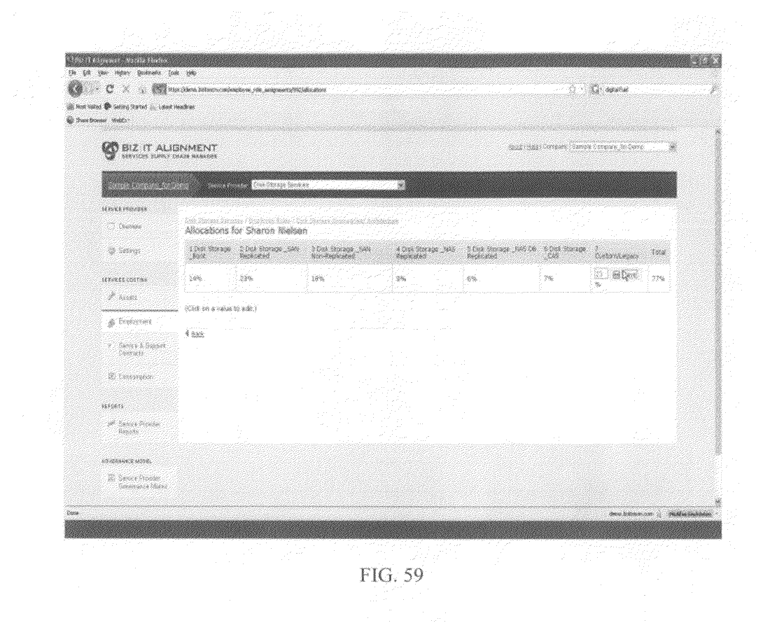

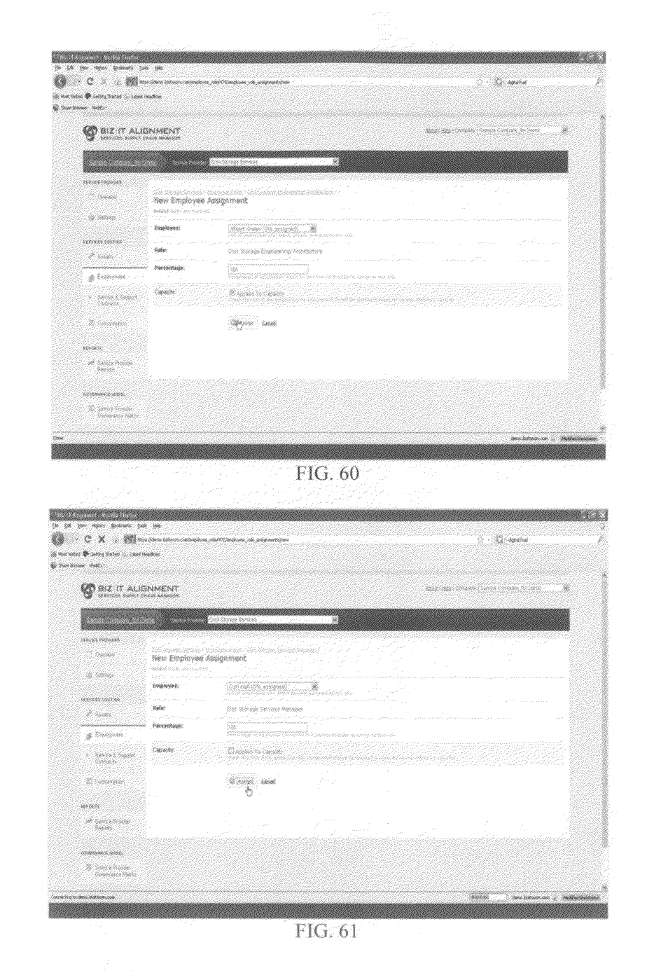

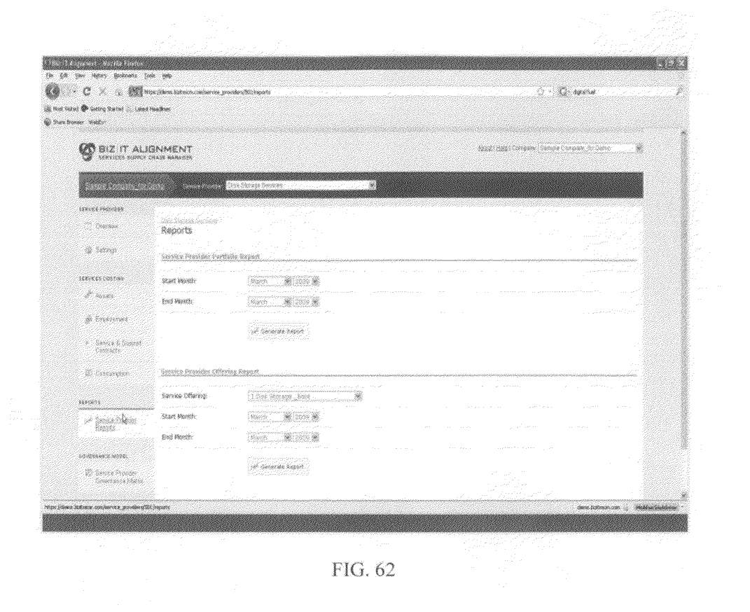

FIG. 54 illustrates how Sharon's time as a manager is planned to be spread out across the seven services relative to her role. FIG. 55 illustrates how to assign Sharon to the Disk Storage Engineering/Architecture Group. As show in the New Employee Assignment entry screen, Sharon is chosen from the drop down list and 50% of her time is to be allocated to this role. Her time is applied to capacity, because that is capacity that needs to be factored in terms of direct service delivery support. As illustrated in FIG. 58, Sharon is shows as allocated 50% to the Disk Storage Engineering/Architecture Group, but she is not yet allocated to any time or expense. FIG. 59 shows how her time and expense is allocated for this role, which is typically different the her role as a manager because her role is different.

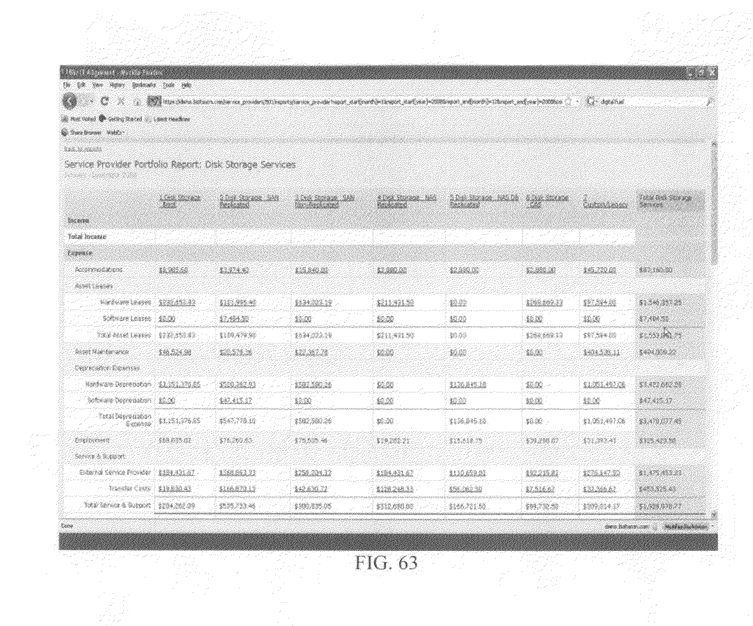

FIG. 60 shows how to allocate another engineer, Al Green. In this illustrated example Al is 100% allocated to this role, with 100% of his time being allocated to capacity the allocation may be done later. FIG. 61 illustrates how to assign Carl to the role of Disk Storage Services Manager. Because he is a manager, the capacity will not be factored in here. Carl is a pure overhead employee. Some managers may be allocated to capacity, others may not. The tool provides flexibility to allocate time to capacity on the case by an case-by-case basis, if need be.

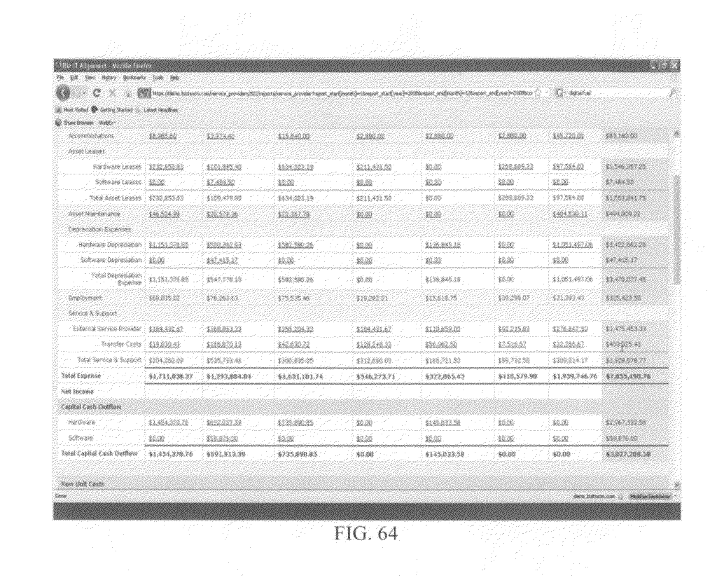

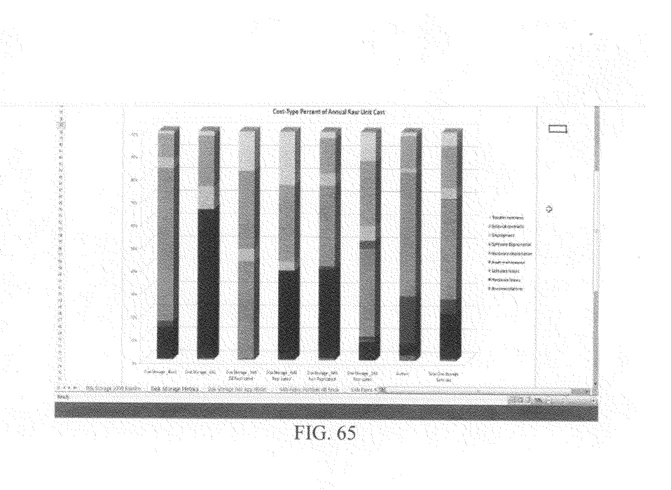

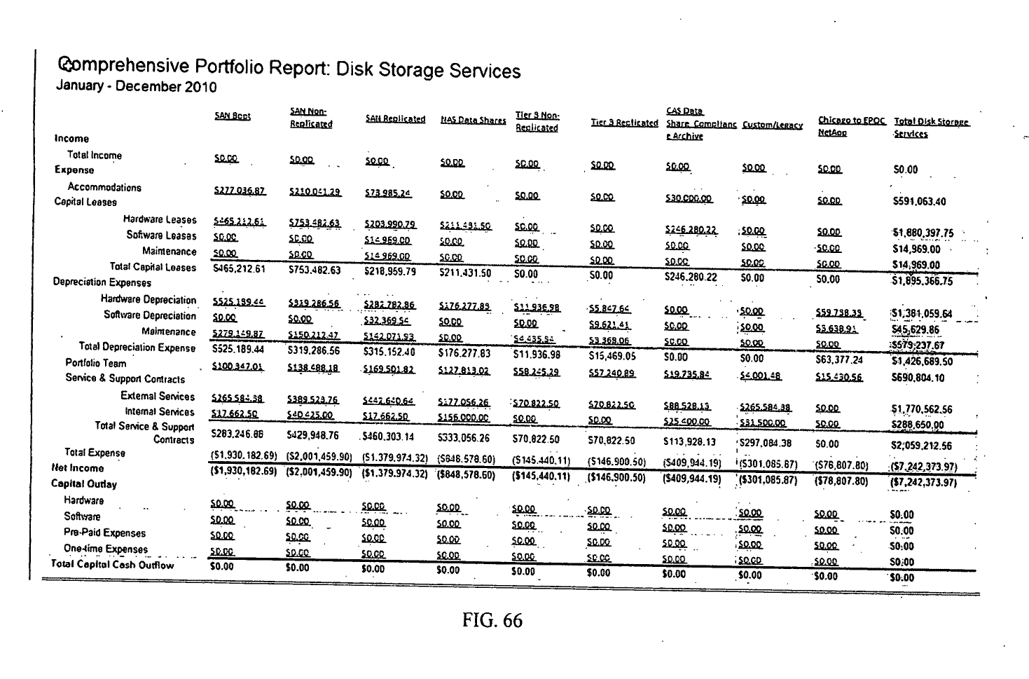

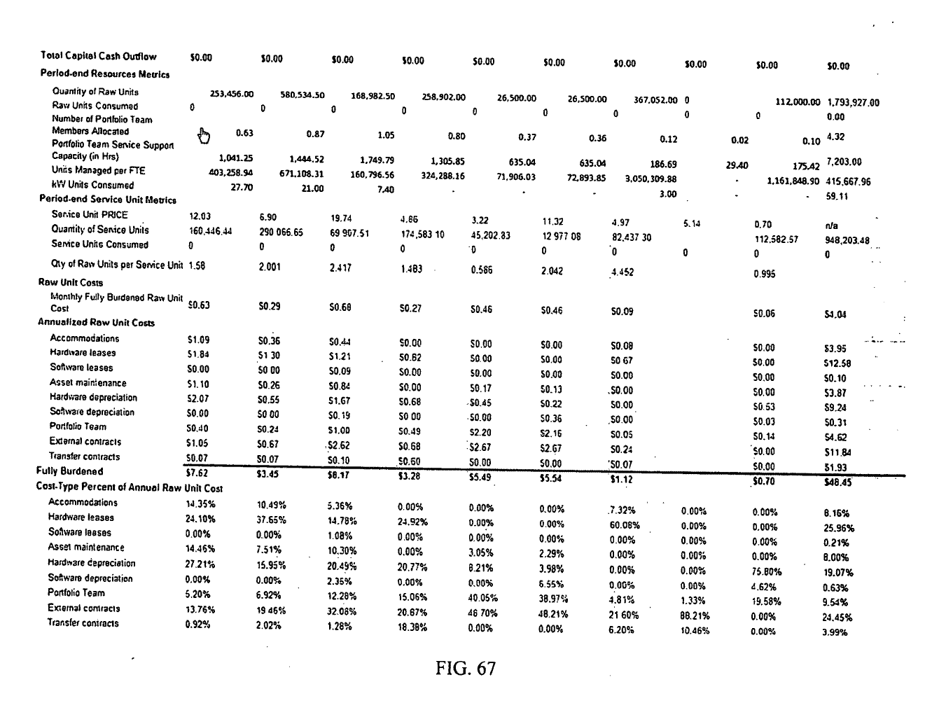

FIG. 62 illustrates how to access the reporting feature to generate the reports to view what the end game looks like. As shown, there is company level reporting, and there is service portfolio level reporting. The tool provides the ability to look at all of the services within a service portfolio, or the user can dive into a specific service that has been previously defined. In the illustrated example, the organization performs an analysis performance in 2008. The resulting report shown in FIGS. 63-65 looks similar to an income statement here. Showing the different services 150, 151, 152, 153, 154, 155, 156 including a total out 157. FIGS. 66 and 67 represent a single view of this same report that illustrates the various naming of fields. The different expense types are also shown—i.e., the different costs in the report. In the illustrated example, there are accommodations, hardware and software, maintenance, hardware and software leases, employment costs, as well as capital depreciation, which is in no way exclusive of the possibilities. Service and support may be broken down further into the external and transfer costs for each service, there is a subtotal of total expenses over the period of this particular report, which is January through December for the illustrated example. And then it totals that out. And, so the user can view a total level as well by expense type.

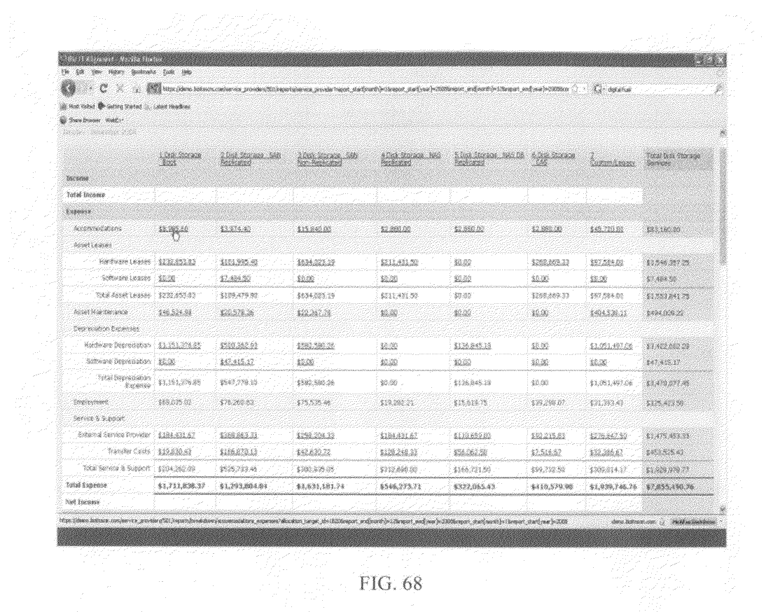

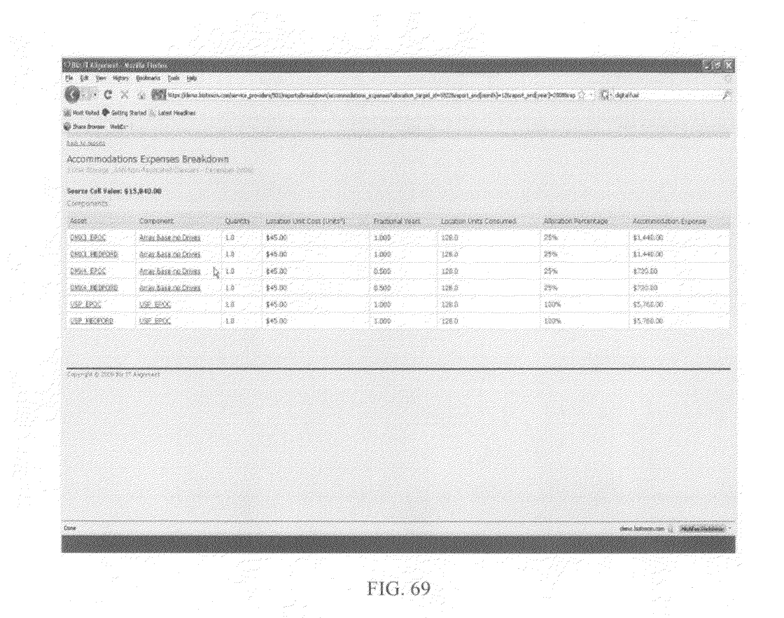

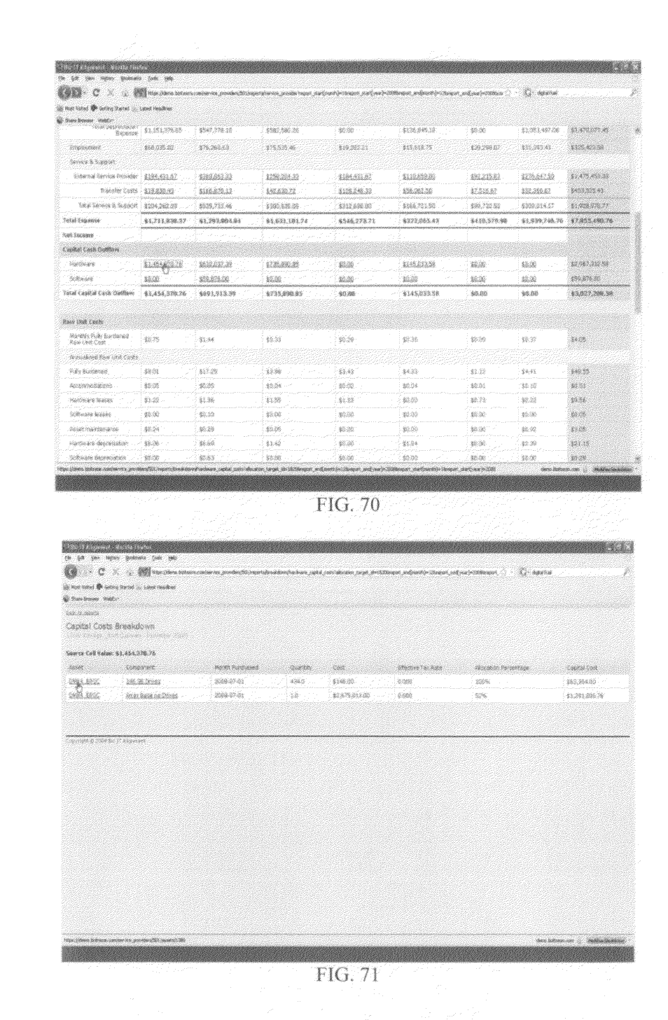

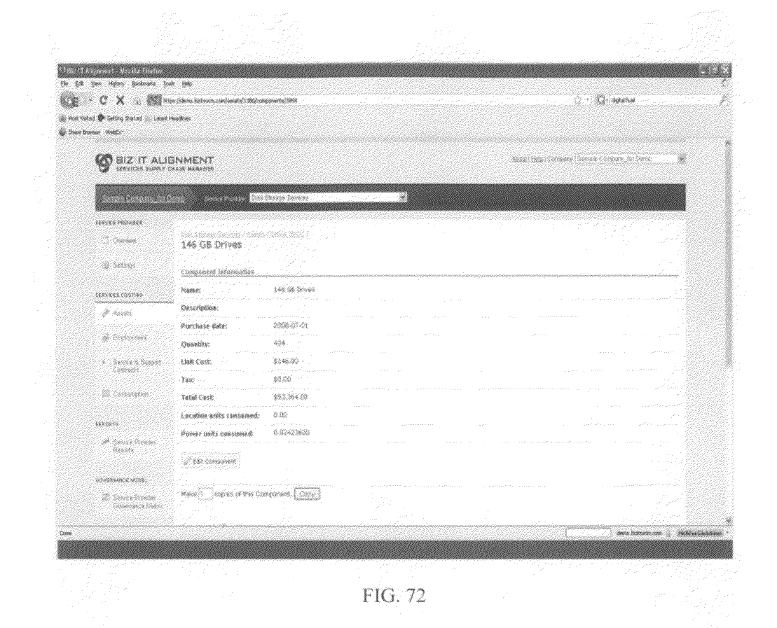

The tool also provides the flexibility to drill down into any of the expenses and costs, as shown in FIGS. 66-68—including the accommodations expense of $15,840. A user may question this value for that period of time relative to these others. So the user selects that particular expense. The underlying page shown in FIG. 69 provides a list of everything that factors into that number. The tool also is configured to show what the cash outflow was for this period of time for each one of the service offerings. So a user can question why the organization spent $1.4 some odd million dollars in total Capital Cash Outflow for the Disk Storage_Boot. When the user selects the amount, as shown in FIG. 70, the resulting page tells the user it was this DMX 4, split out the different components as shown in FIG. 71 including the allocations. A lot of good information that you can just continue to drill down. So if I want to drill into the 146 GB Drive shown in FIG. 71, which are referred to herein as live links, the user is provided a page that shows additional information such as the components shown in FIG. 72. This drill down provides a very defensible, rationalized representation of the output of any report.

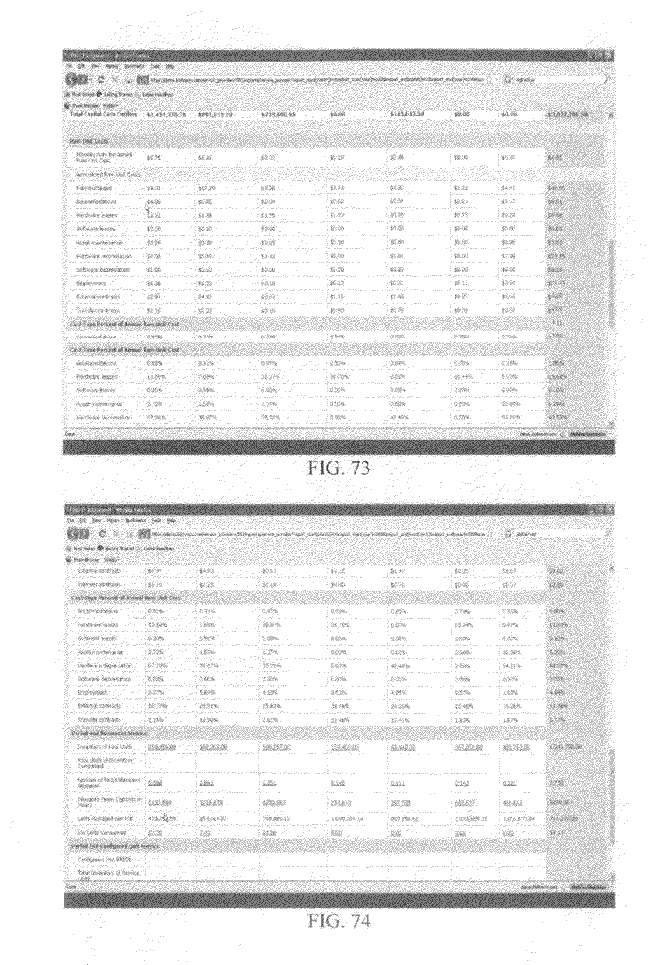

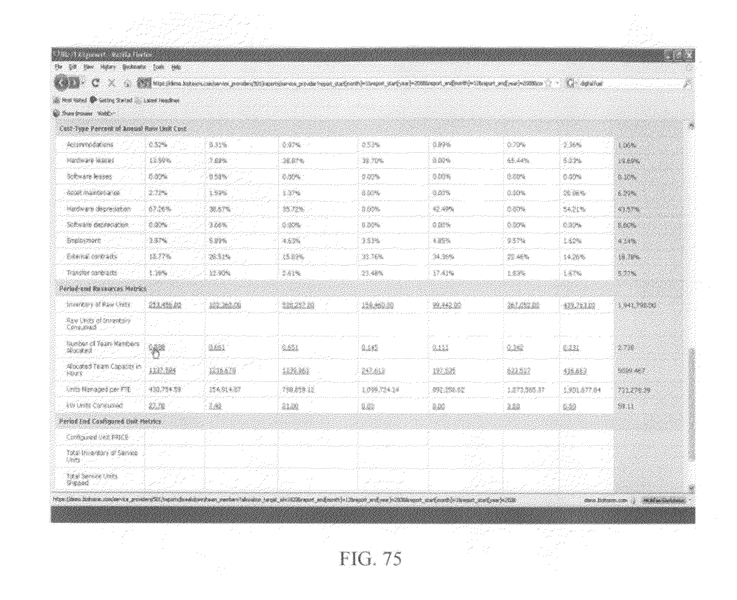

FIGS. 73-75 illustrate the information that makes up unit costs. So the first piece shown in FIG. 73 is monthly unit costs. FIG. 74 shows the annualized raw unit costs. So it's going to say, wow, for this service offering, the raw unit cost—remember when that cost was used for price adjustment previously—this is the cost piece that starts the base for applying the price adjustments against. And then, for this $9.01 unit cost 165, here are how all those expense types factor into the total, fully burdened unit price. Capacity is illustrated in FIG. 75 in Resource Metrics 166, including the respective percentage as shown in FIG. 74. To calculate the tool uses the expense number and the capacity number (e.g., raw number of units). The tool also provides the ability to view how many team members are associated with each one of these service offerings, based on that allocation exercise done previously. So these are KPI metrics (Key Performance Indicators) that, again, as a user is tracking and looking at levels of efficiency, the tool shows where the opportunities of what maybe are inefficient and there is opportunity for improvement. Or, ones that are very efficient to review and analyze some more and find out why, and maybe leverage that and those lessons learned across some the more inefficient ones. The tool, as shown, also displays the number of hours that are associated with capacity, again, over the period of this report that are associated. The tool also shows units managed per FTE. Team hours within capacity can be—FTEs as well as contractors. So, that's why the tool splits these out separately. And finally power consumption is displayed. We want to be able to on every report, what degree of power is being consumed by service. So now a user has the ability to look and say, for every service over any given period of time, he or she can tell what its expense was, what its income was, what its cash outflow was, what its capacity was, and what its power consumption was. The tool could tell a user for each employee, how much time was associated with it.

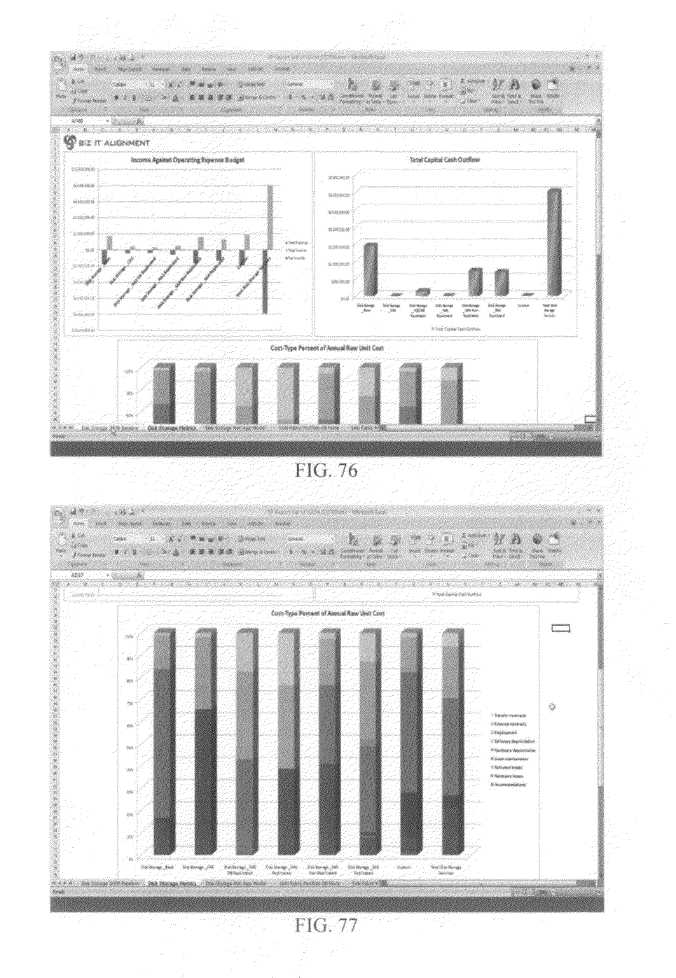

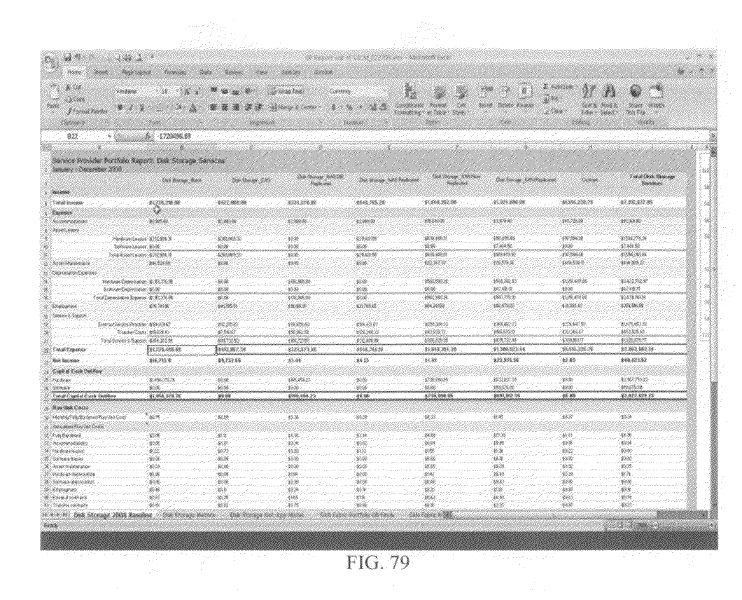

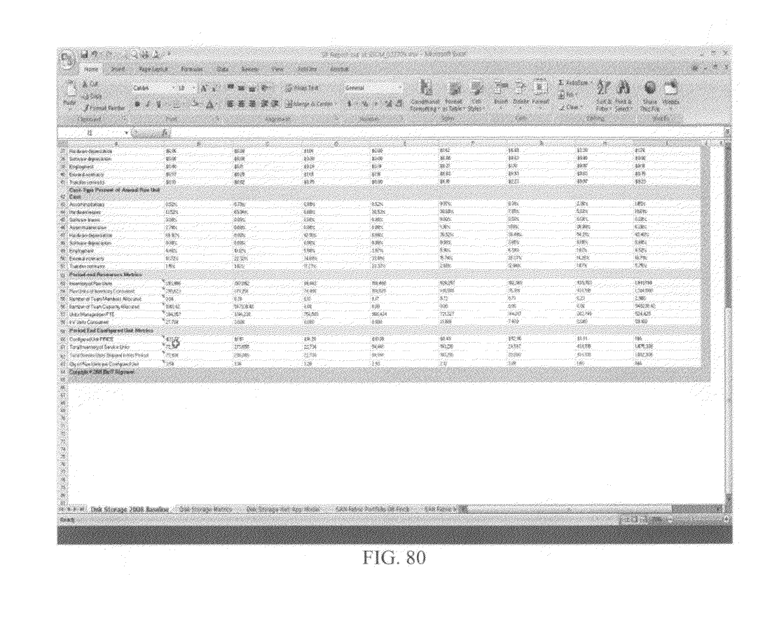

The unit price shown in FIG. 79 is a link from that cost to price adjustment calculator shown previously in the service portfolio requirements matrix. In accordance with this aspect of the invention, the tool is able to calculate service inventory units because it is a percentage of raw unit quantity. Typically, it is a cost to price adjustment—the exercise done previously that resulted in 2.1 raw units, so as to get to a fully configured sellable service unit price. FIGS. 76-78 show a report of what the information shown in FIGS. 66-68 and 73-75 looks like when it's completed. These reports and information export nicely out into Excel, as well as FIGS. 79 and 80 illustrate another report generated by the tool of the present invention, for example, taking units shipped multiplied by that unit price to get to income. Income less the expenses provides net income. So, the goal for most IT organizations that are zero sum gain is, at the end of a year, and in the illustrated example of FIGS. 79 and 80 in particular at the end of 2008 the goal is to get as close to zero as possible. In this instance, with close $8 Million expense line and a positive $48K net income, not a big deal and is actually pretty good. So this tool is not intended to be a general ledger that is keeping track of every transaction because, what can be done is make up for that variance at the end of the year, plus or minus. So take that $48,000 of “net income” and spread that amount out over all of the units within the service portfolio, which, in this case, it means a credit that is spread across customers of the service(s). The tool also provides certain metrics that can break this information out that can become real nice for publishing out to customers as shown in FIGS. 76-78, for example, income against operating expense budget tracks total expense, income, and net income. As stated previously, the goal is that net income is close to zero. As shown in FIG. 76, it is close to zero across the board. And then for total, it's almost nonexistent. So that's exactly what these zero sum gain. IT organizations are looking for the Service Portfolio, obviously, wants that net income to be as positive as possible. FIG. 77 illustrates info based on cash outflow by service offering, a cost type of percent of annual raw unit costs. The information in FIG. 77 is what customers care about when ordering the service—they want cost transparency. So based on the allocations, there is a high degree of variance by service within a single service portfolio.

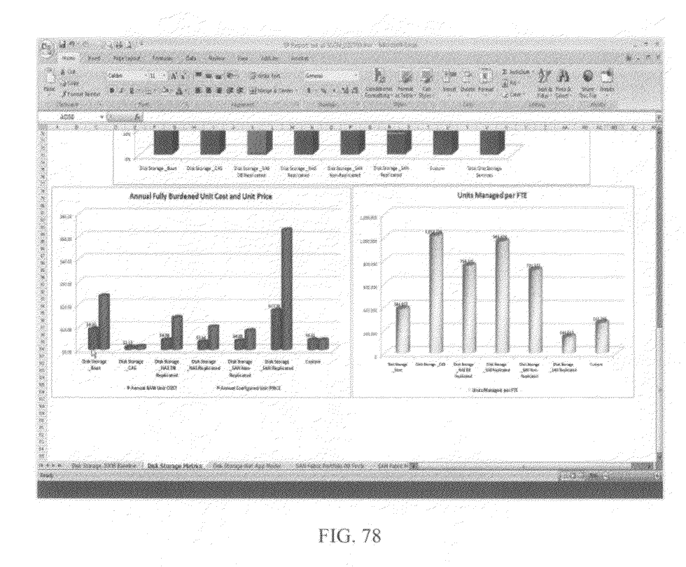

FIG. 78 shows burdened costs versus price, which visually represents the cost-to-price ration illustrated and described previously. FIG. 78 also visually depicts the units managed per FTE, a very important metric for a lot of the managers.

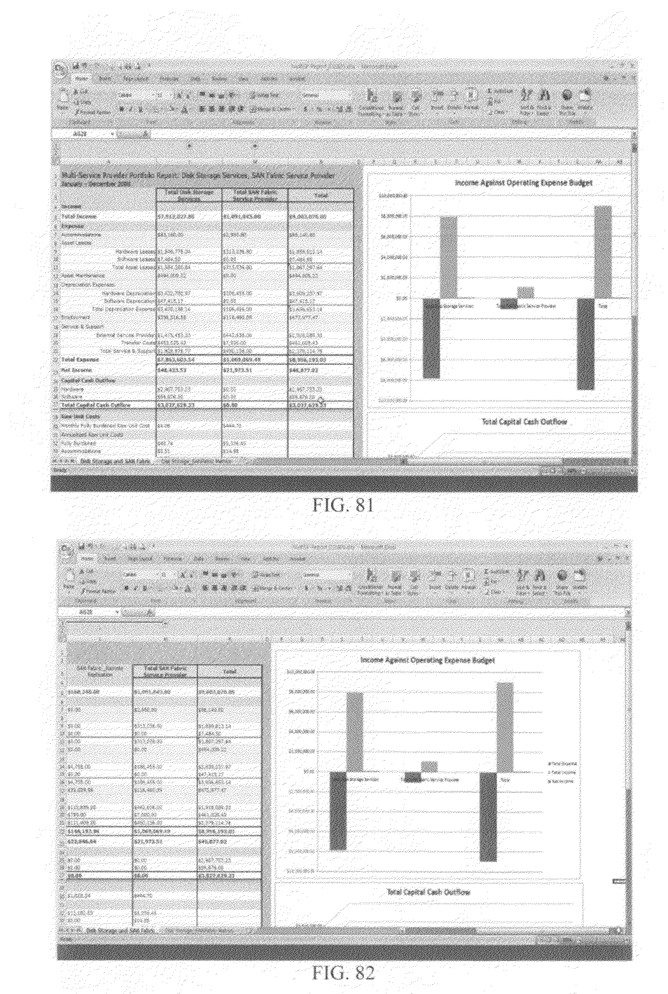

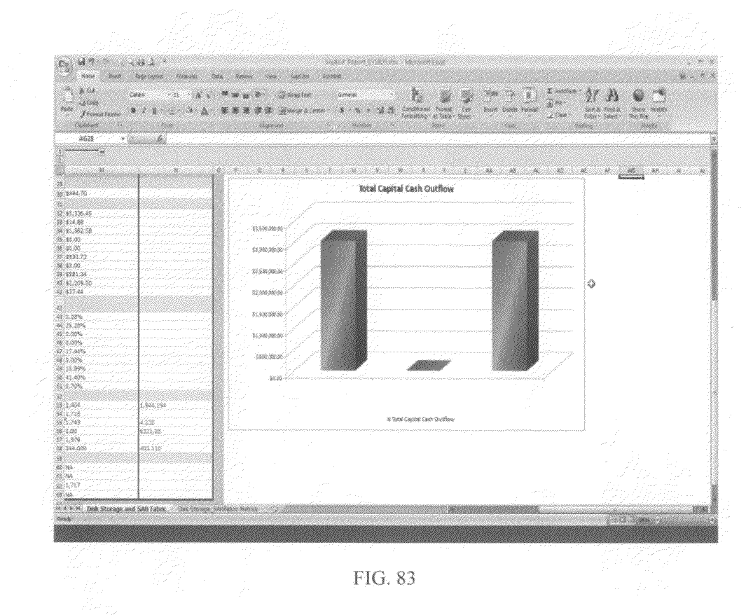

FIGS. 81-83 illustrate the ability of the tool to do multi-service portfolio reporting. Another report is illustrated that we ran out of the tool for Disk Storage Services and SAN Fabric Service Portfolio. The report pulls in the totals for each service portfolio and presents them side-by-side. In the illustrated example, the report first provides subtotals, and then totals them up. The use can view service portfolios side-by-side to get more of a macro view. The report still allows the user to understand a little bit more behind the numbers by expanding out, diving down and performing drill-downs as discussed previously. FIGS. 82-83 show the same type of metrics discussed previously that graphically illustrate only the Disk Storage and SAN Fabric Service Portfolios. There are going to be fewer because of the blended view, but again, very, very powerful. FIGS. 81-83 illustrate dynamic analytics—on the spot, kind of, “what if” modeling in accordance with one aspect of the present invention.

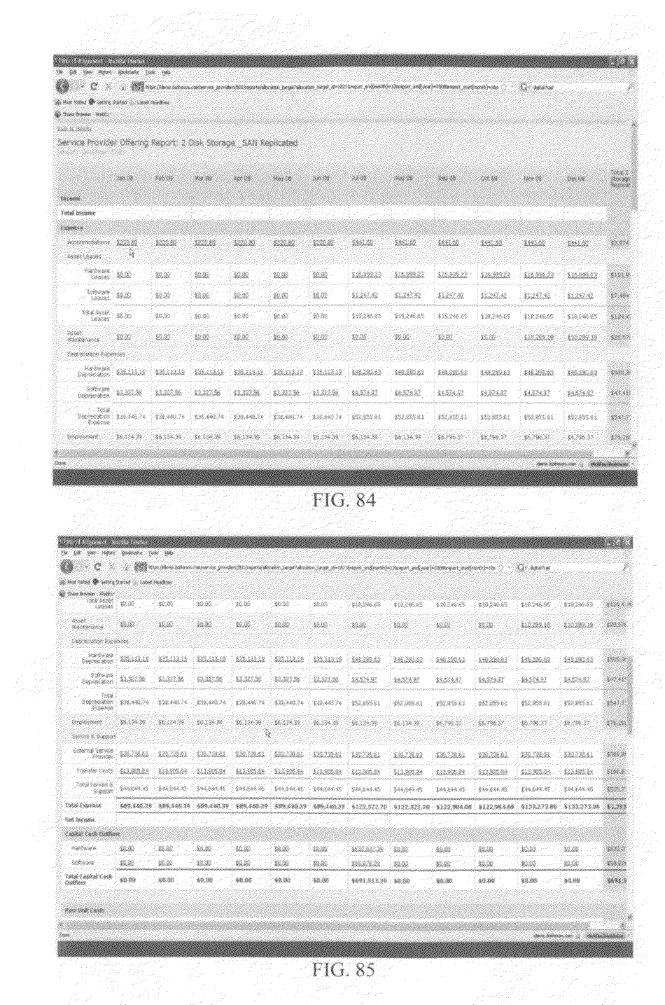

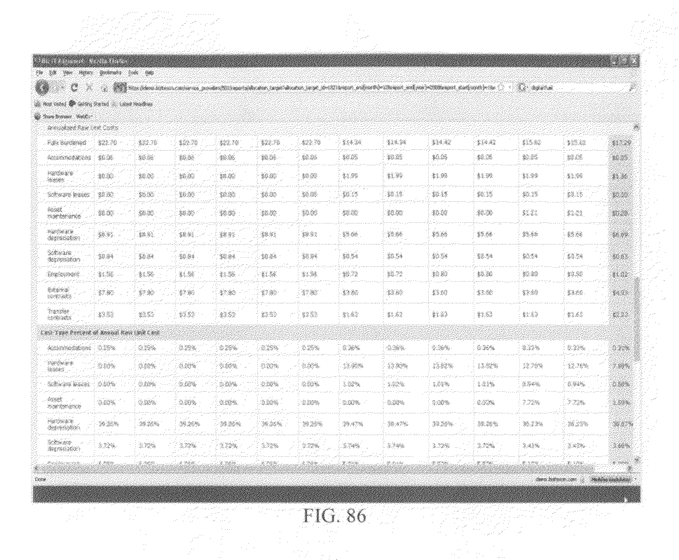

FIGS. 84-86 illustrate drilling down to the single service portfolio to display the January through December period. This view is useful to determine when certain expense types (e.g., capacity, cash) hit the books as expenses. This becomes very helpful in terms of budgeting and assessing seasonal types of purchases. Service portfolios are able to do purchasing planning so that they are deferring investments as long as.

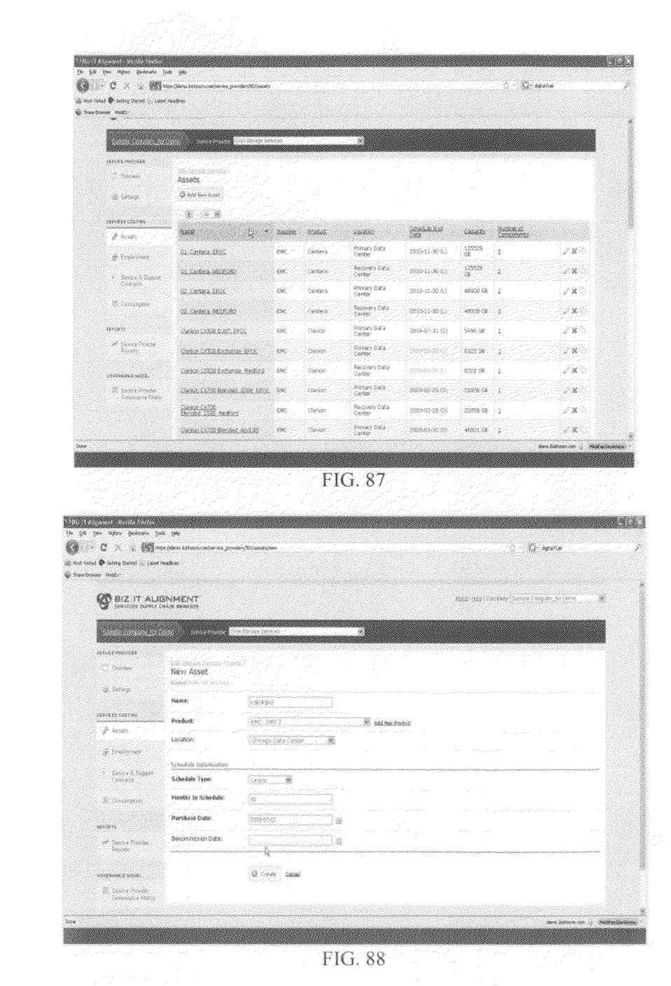

FIG. 87 shows sortable a table of all the assets that are associated with the service portfolio, showing the name, product, supplier, scheduled end date, capacity and number of components. FIG. 88 illustrates the input screen for creating a new asset that will be listed in the table of FIG. 87. The user can define the name of the asset, the products (which automatically knows the supplier), the location, and schedule information, which includes schedule type (lease or depreciation), moths in schedule, purchase date and decommission date if applicable. The schedule information is an important item to report, as will be seen in the following discussion. So this aspect of the invention is designed to simplify the input for the technology managers, because if it is too complicated or if it looks like some horrific spreadsheet, then they run from it and none of the data gets input or it does not get input properly. The tool is intended to be very straightforward and grounded in the types of fields that technology managers understand and would expect to know. Questions that can be answered at a glance include: are we buying this using capital dollars or are we leasing; what's the monthly schedule; what is the start date and when does this thing hit; when do we start paying for it; when does capacity start getting factored to name a few.

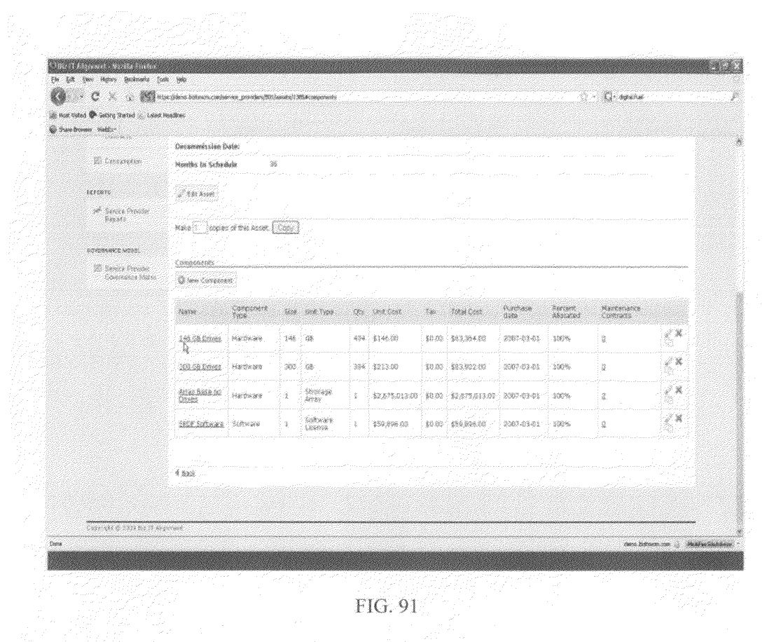

As shown in FIGS. 90 and 91, the tool will calculate out what the schedule end-date is based upon the information entered in the screen of FIG. 88. The “L” and “D” in the column “Schedule End Date” indicates at a glance whether the asset is leased or depreciated. According to the legend in FIG. 90, anything highlighted in orange indicates the particular asset is going to be off schedule in less than 12 months and red indicates that the asset is no longer on schedule at all. So, again, at a glance, the tool provides feedback so that a technology manager can identify assets that are highlighted in orange and start putting a plan in place for technology refresh. The present invention is driving a real proactive, efficient management structure. The decommission date in FIG. 88 is the date where the asset is removed completely from both capacity and cost.

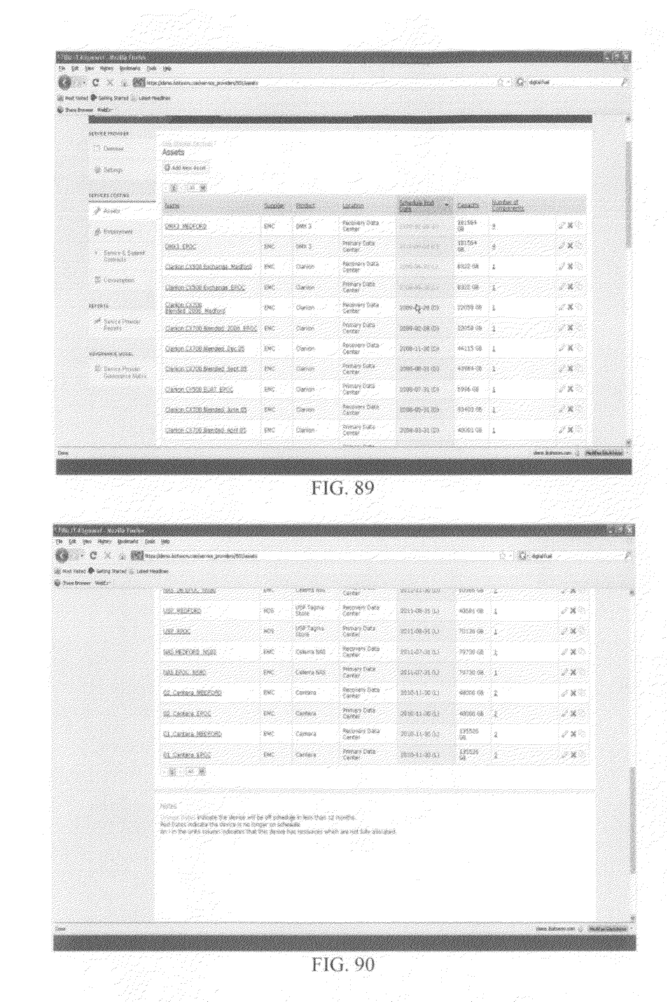

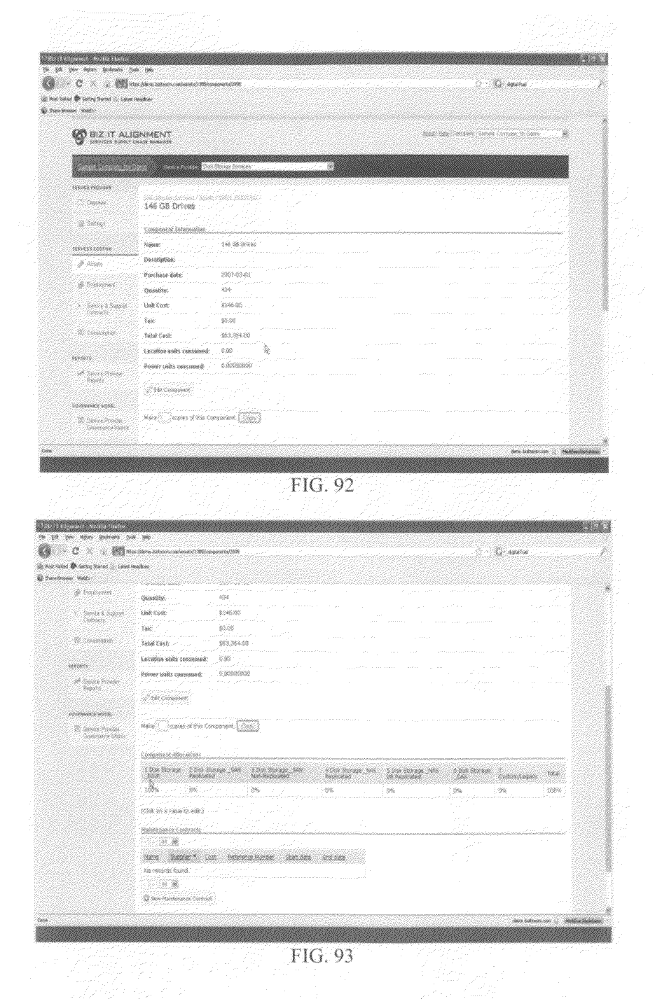

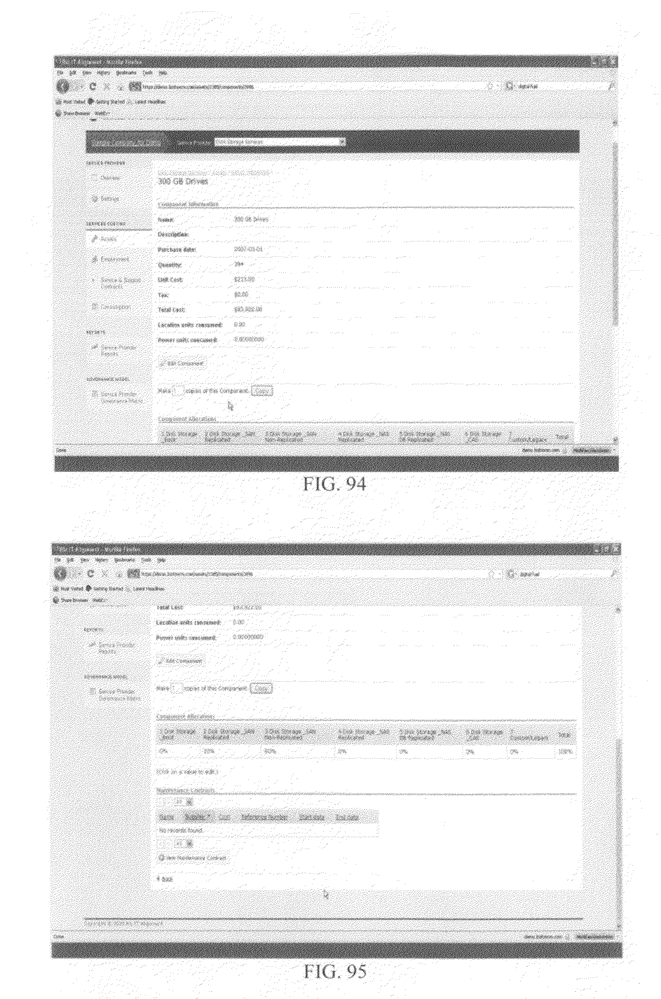

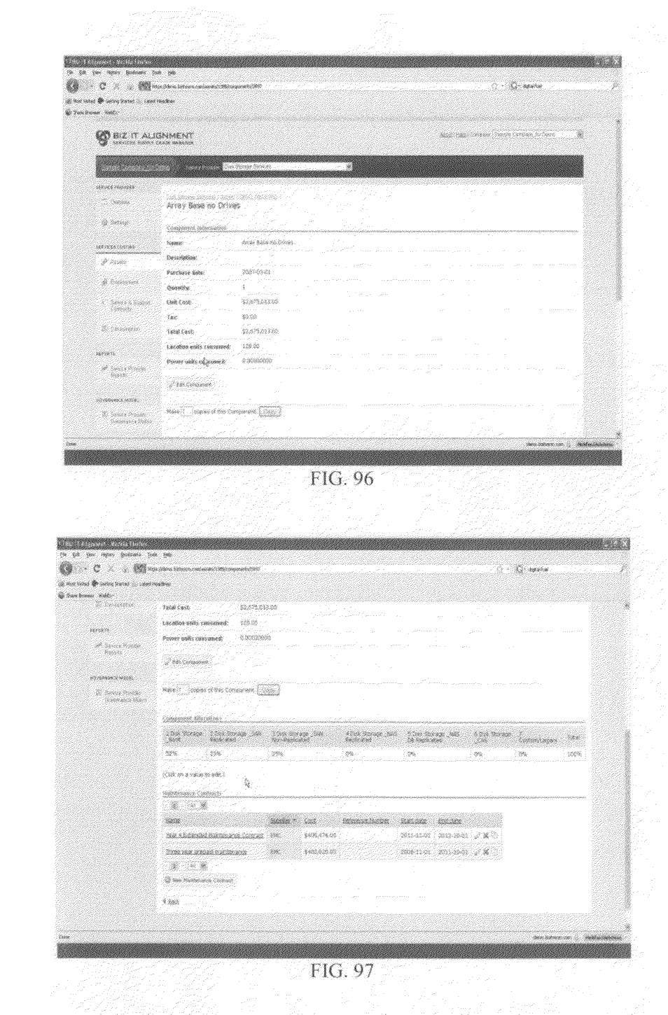

FIG. 91 illustrates the underlying components associated with the DMX MEDFORD asset 200 shown in FIG. 89. Each of the components is expandable by selecting the name of the component, such as the 146 GB Drives 205, 300 GB Drives 210 and Array Base No. Drives 215. FIGS. 92 and 93 illustrate the underlying information associated with the 146 GB Drives 205 such as the purchase date, quantity, unit cost, tax, total cost. As shown, the drill-down also specifies what service portfolio has been allocated this asset. For the 146 GB Drives, as shown in FIG. 93, 100% of the asset has been allocated to Disk Storage_Boot. FIGS. 94 and 95 illustrate the underlying information associated with the 300 GB Drives, including the allocation of 20% of the asset to Disk Storage_SAN Replicated service portfolio and 80% of the asset to Disk Storage_SAN Non-Replicated service portfolio. FIGS. 96 and 97 illustrate the underlying information for the Array Base No Drives 215 with the allocation and associated maintenance contracts.

That is why the parent-child designation is critical, because the tool of the present invention is configured to allocate components of a shared asset differently, sort where these drives get populated and allocate whatever that allocation method is. So a user needs the control to be able to set the maintenance schedule dates, differently or uniquely from the components. And then the user desires the ability to do multiple maintenance contracts and not just edit the existing one. Otherwise, again, the tool loses that historical data.

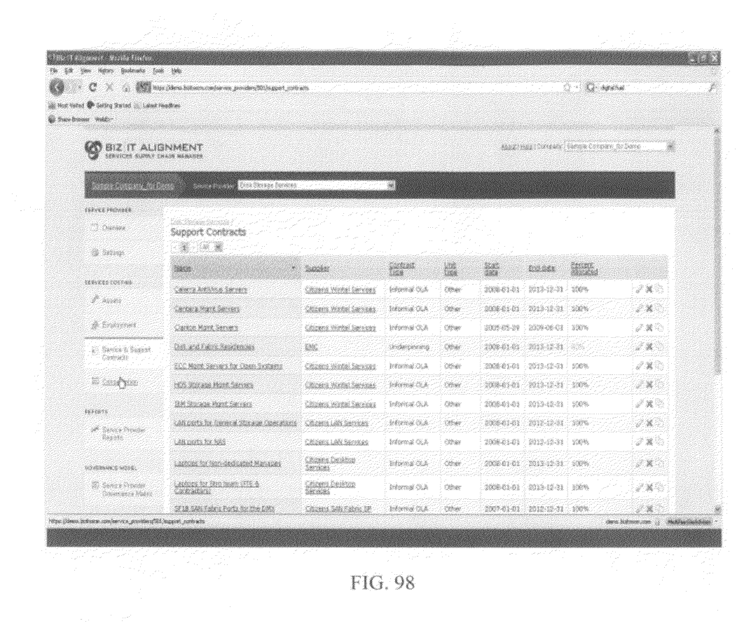

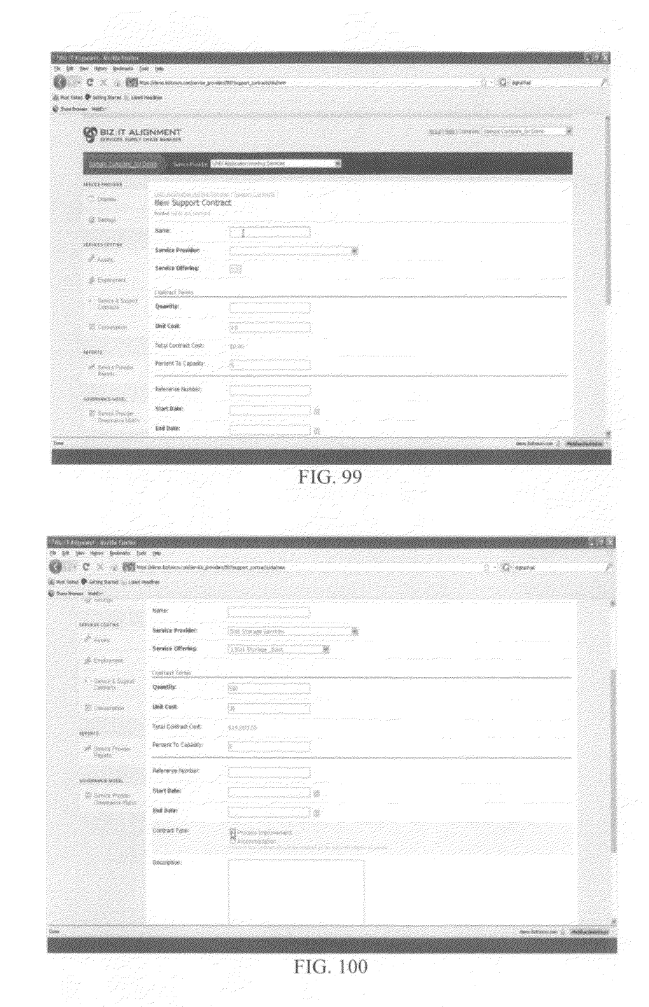

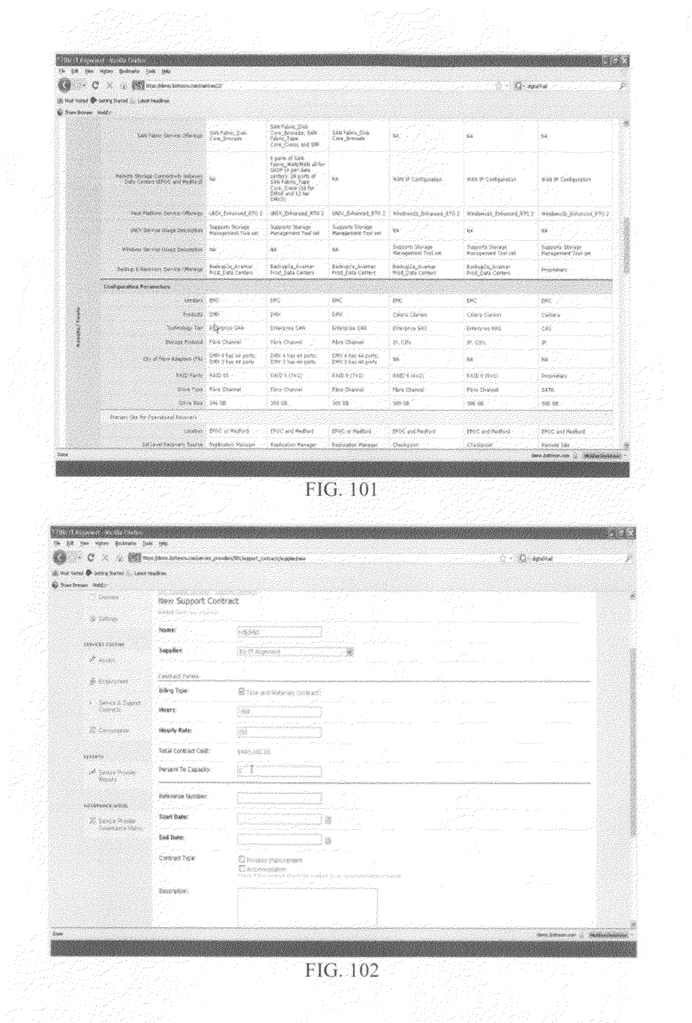

As shown in FIG. 98, there are analytics just in the report in terms of what is being manipulated from an input perspective, e.g., the name of the contracts, the supplier, the contract type, the unit type, the start and end date and percent allocated to name a few. Again, the tool provides different sorting capabilities. FIG. 98 illustrates the service and support contracts associated with another aspect of the present invention. FIGS. 99 and 100 show the input screen for creating a new support contract.

FIG. 101 shows the opportunities for the integration and automatic build-out of the service portfolio requirements matrix. So, for example, the user knows every OLA, based on the process described so far that is associated with this disc storage service portfolio. The tool therefore knows the vendor, the product and how much cost is associated with it, etc. The tool pulls vendor's products right from the allocations. So when a user enters a product in this storage service portfolio, the tool knows the identity of the vendor. Some of this information is custom, but as much of it is being populated and pulled from other pieces making it possible to limit the entry of data in multiple times so that it's not reconciled, etc. This pulls it right from that cash outlay as well as right from the capacity numbers.

FIG. 102 illustrates creating a new support contract that isn't an OLA. The entry screen provides for the entry of the underlying data, such as the name, supplier, the billing type (e.g., is it a time and materials contract), hours and hourly rate, the total contract cost and the percent of the contract to allocate to capacity. In one embodiment, the tool will automatically associate the capacity of the contract with one of the roles that have been predefined within the service portfolio. Entry of information associated with the support contract also includes the start date and end date, and whether the contract is a process improvement or accommodations. If the contract is an external contract the tool will ask the following questions to determine if this contract should be treated as a Capital purchase or an Operational expense: Which answer best describes the nature of the services provided in this contract? (a) Services that support existing day to day operations; (b) One-time Services that prepare one or more assets for use within operations; (c) One-time services that improve/optimize the useful life of one or more assets; Or (d) Other (Please provide brief description).
If the answer is “a” then the tool treats the contract as Opex
If the answer is “b” or “c” then the tool treats the contract as Capex
If the answer is “c” then the tool sets up an alert in the Portfolio Home Page that this contract needs to be reviewed and ultimately reclassified as either “a”, “b” or “c”
   This does not apply to internal/OLA contracts because they will never be treated as anything other than Opex at the contract level. But to clarify, the internal service such as Professional Services may be set up as a “Pre-business operations” service that factors in annualized unit price, the Year 1 Investment price and the 5 Year TCO much in the same that a capitalized asset is treated

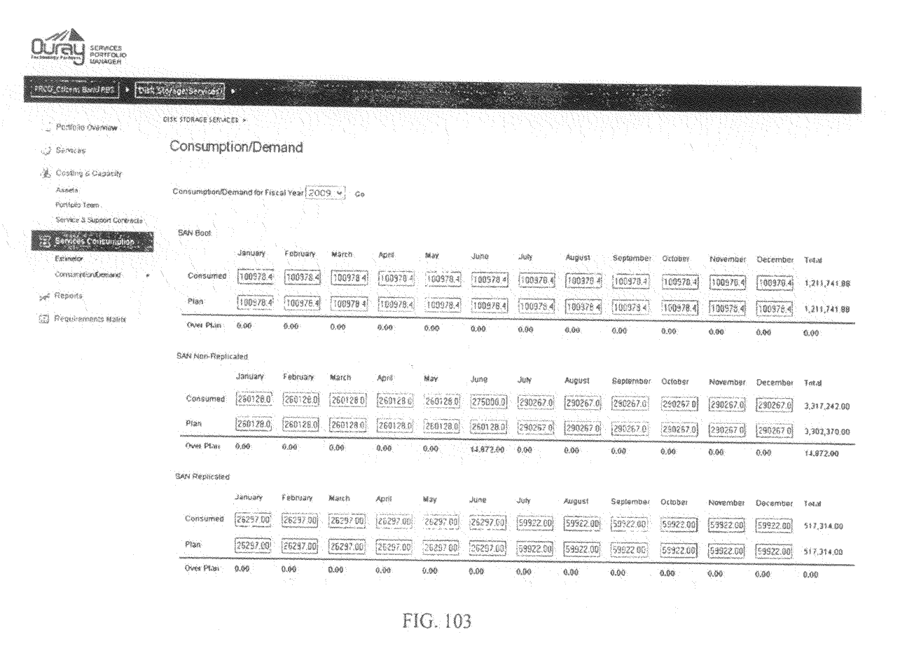

The tool also provides a services costing aspect referred to as services consumption. There are three pieces contemplated under services consumption: the estimator, the demand forecast and consumption. Consumption is basically the integration point from whatever the other external tools are. The input for consumption is targeted for service catalog applications that have the ability to report on the quantity of service units consumed over a user defined period of time. As shown in FIG. 103, this input can be set up as a manual or integrated import into the “Consumption/Demand” module of SPM to deliver the “Consumed” quantities by service by month. This page also allows for the articulation of “Planned Consumption” and the difference between actual and planned per period. As shown in FIG. 66, this “Consumed” value is very important because it is this value multiplied times the monthly service unit price that determines the “Total Income” value that is in the Comprehensive Portfolio Report.

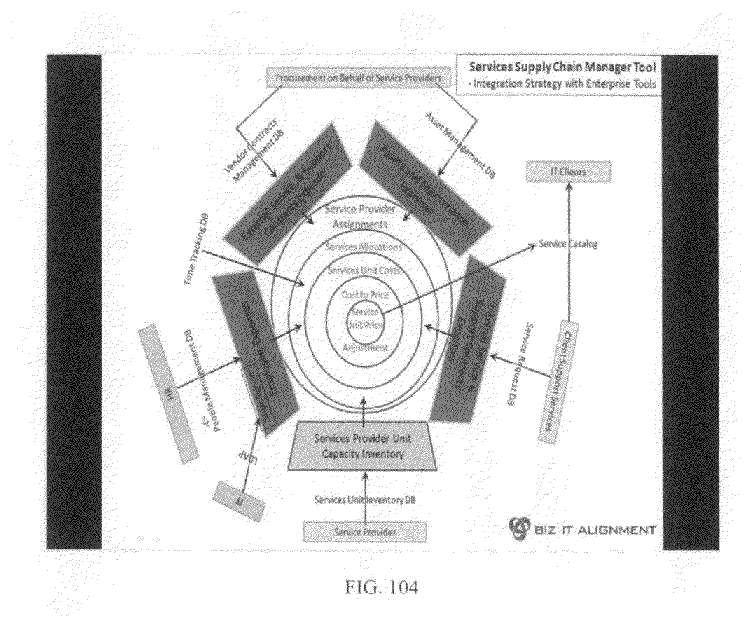

FIG. 104 defines the integration with external tools. As shown, there are client support services, like a service catalog. It has a service request database that can run a report for the service offerings that are in the disk storage services over a defined period of time and it will just capture the information into service allocations, and that, again, is what drives the income. There are other pieces illustrated, such as PeopleSoft, LDAP integration, Time Tracking databases, Vendor Contracts database, Asset Management databases and Service Request databases to name a few. Those become the capacity and they get pulled into the tool and, depending on where they live, assets sometimes are allocated out. Some come right in and allocate one-to-one, like the time-tracking. But all of these translate to getting to this services unit cost and then the cost to price adjustment, so that you get ultimately to that service unit price that gets exported out into a service catalog. So, everything else is more of an input to get to a rationalized unit price that gets published to consumers of IT services.

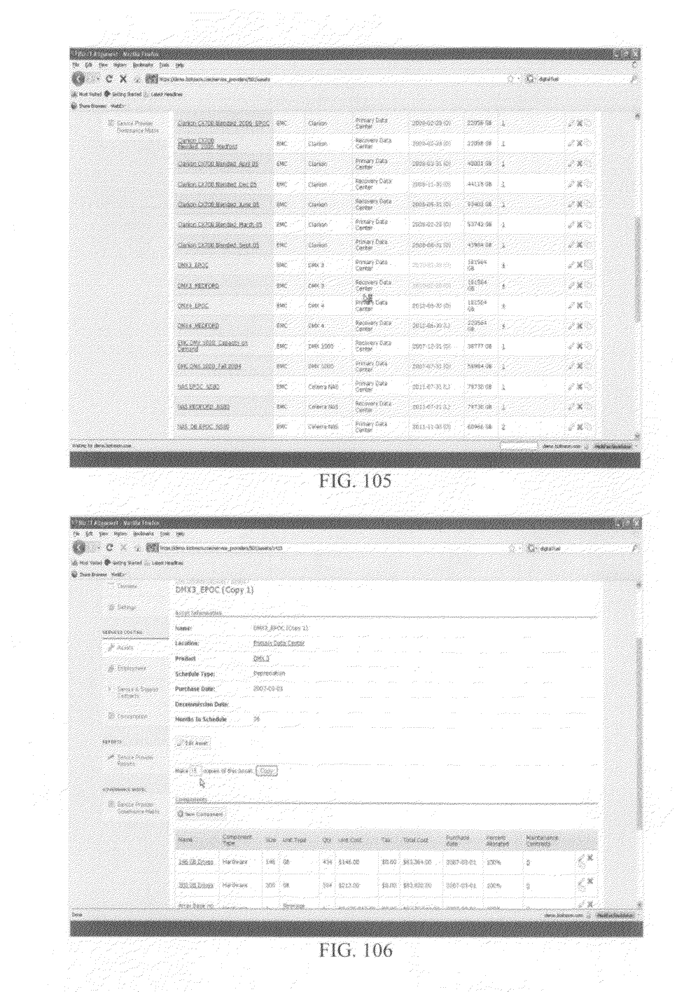

FIGS. 105 and 106 illustrate the cloning capability in accordance with another aspect of the present invention. The idea behind cloning is to make it simple for people to enter data without having to type in multiple things. In the illustrated example, DMX 3 Medford was created from DMX 3 EPOC. It is built out with its underlying components and all the allocations were already complete. All the user is requires to do is change its name and make it unique at the asset level. And, if there is anything else unique, maybe the dates, you can find it right away and go into the tool and edit it.

Structural Overview of the SPM Database

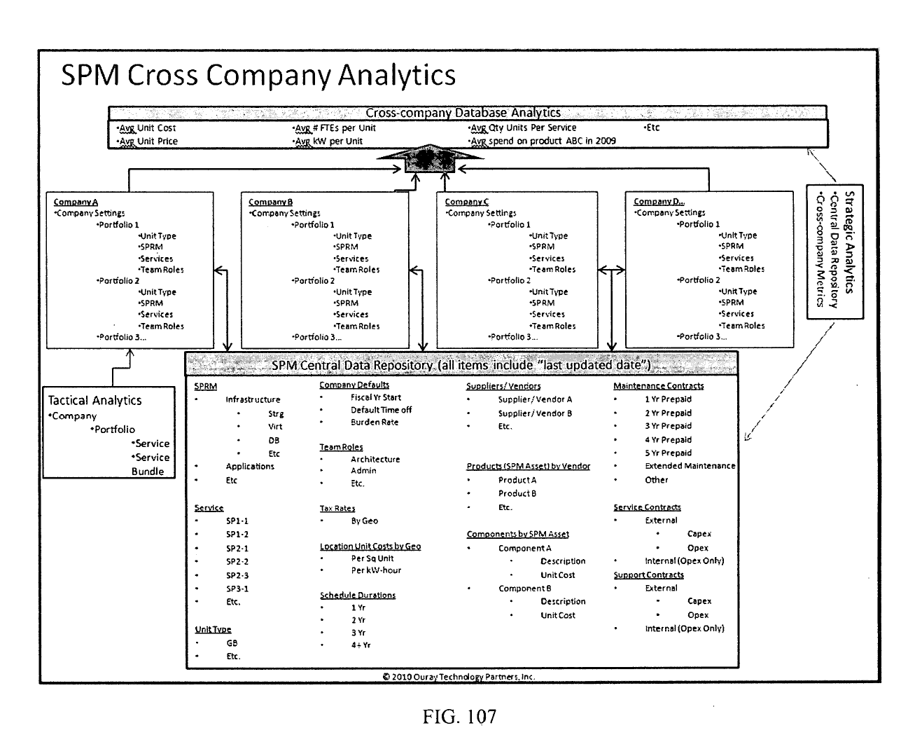

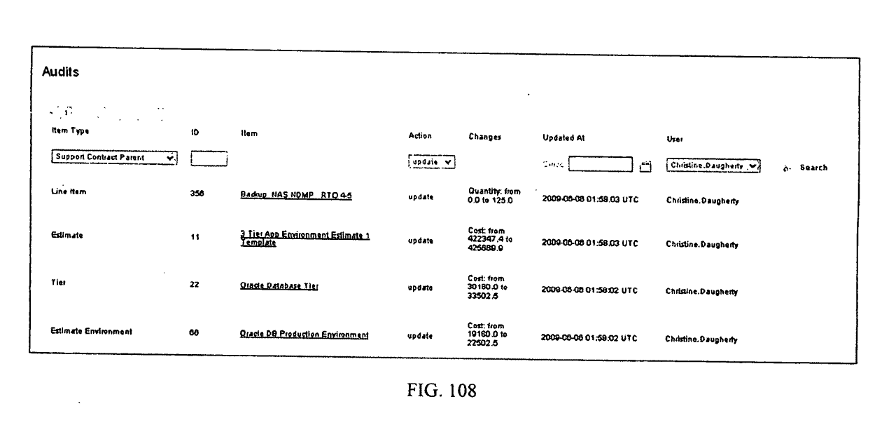

The SPM will be re-architected to have a centralized data repository that includes a table listing of all potential resources options that can be added or included in a new instance of a “Company” as is defined by the tool. See the large box in the center of FIG. 107 below entitled “SPM Central Data Repository (all items include ‘last updated date’). ” Any user that wants to input an item that is included in the SPM Central Data Repository, they will be presented a list of options. Each of these options in the database have a unique ID so that even if users across disparate companies modify these names once they are brought into their instance to fit their company's nomenclature, that item's IDs will not change so that there is uniformity of that item across all companies. This is critical to support the requirement to perform analytics across multiple companies but for common items (e.g. a query across 20 different companies for the average price per medium range desktop system). In this example, the medium range desktop might have unique naming conventions for that common desktop profile, so without the common (and hidden) ID, there would be no way to perform a cross company query. Also, if any user adds a “new” item because they cannot find a match to the existing list (as is available today), then the SPM tool knows to add that item into the appropriate category within the SPM Central Data Repository. This capability provides the ability to query across multiple companies within a database instance thus providing valuable analytics on market trends are which may provide insights that can influence product/service development, marketing, sales, etc.

User Permissions

### User Type: “User”

Employee Level Permissions

For employee level permissions the “User ” has the following permissions and restrictions:
Ability to see employee information associated only with the service provider in which they belong. In order to protect confidentiality, these employee pages encrypt all information pertaining to salary and earned vacation time.
This user type has a read-only view of his or her own employee information
This user type cannot edit employee information of any employee
This user type cannot delete any employee. If this is required, the request must go through a change control process.
This user type cannot add a new employee into the company. If this is required it must be done at the Service Provider Manager level.
This user type can view the entire company hierarchy report but employee page access is consistent with the “User” policies described above.

Contract Level Permissions

For contract level permissions the “User” has the following permissions and restrictions:
Ability to see only the contracts that have an association (either as a supplier or a consumer) with this user's Service Provider(s).
This user type has both read and write access of visible contracts with the following limitation:
   The unit price and unit quantity are not visible or editable
This user type cannot add a new contract
This user type cannot delete an existing contract.

### User Type: “Manager”

Employee Level Permissions

For employee level permissions the “Manager” has the same permissions as those of the “User” with the following exception:
This user type can add a new employee into the company with the following forced application rule: the user adding the employee will be the manager of that employee. This rule prevents any user from arbitrarily changing an employee's manager thus making confidential employee data visible to unauthorized personnel.

Contract Level Permissions

For contract level permissions the “Manager” has the following permissions:
This user type has full read and write access to visible contracts
This user type can create and delete contracts
This user type has full edit permissions including unit price and unit quantity

### User Type: “Administrator”

For users who need global read and write permissions across all service providers. The only permission this user does not have is the ability to delete Employees. That permission is reserved only for the “Root” user type.

### User Type: “Root”

Application administrators who have full access to the application for setting up users, managing user permissions, passwords, company access and service provider access. This user has exclusive access to the Audit Log (see Figure which provides transparency into all modifications to the database.

It should be appreciated that reference throughout this specification to “one embodiment” or “an embodiment” or “one example” or “an example” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” in various portions of this specification are not necessarily all referring to the same embodiment.

It should also be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. Inventive aspects lie in less than all features of a single foregoing disclosed embodiment, and each embodiment described herein may contain more than one inventive feature.

While the invention has been particularly shown and described with reference to embodiments thereof, it will be understood by those skilled in the art that various other changes in the form and details may be made without departing from the spirit and scope of the invention.

I claim:

1. A computer implemented method to capture, organize, analyze and manage an IT service portfolio supply chain, the method comprising:
receiving a plurality of information identifying service delivery resources (e.g. assets, components, contracts and employees) associated with a service portfolio in the IT service supply chain;
storing the information in a web-enabled database application;
performing associations between the service delivery resources and a portion of the information for the service portfolio;
performing associations between the employees and a portion of the information for the service portfolio; and
outputting a report that displays the allocation of the assets and employees associated with the service portfolio.
